(19) United States
(12) Patent Application Publication
(10) Pub. No.: US 2013/0346068 A1
(43) Pub. Date: Dec. 26, 2013

(54) Voice-Based Image Tagging and Searching

(71) Applicant: APPLE INC., Cupertino, CA (US)

(72) Inventors: Jan Erik Solem, Bjarred (SE); Thijs Willem Stalenhoef, San Francisco, CA (US)

(73) Assignee: APPLE INC., Cupertino, CA (US)

(21) Appl. No.: 13/801,534

(22) Filed: Mar. 13, 2013

Related U.S. Application Data
(60) Provisional application No. 61/664,124, filed on Jun. 25, 2012.

(51) Int. Cl. G10L 15/26

(52) U.S. Cl. CPC G10L 15/265
USPC 704/9

(57) ABSTRACT

The electronic device with one or more processors and memory provides a digital photograph of a real-world scene. The electronic device provides a natural language text string corresponding to a speech input associated with the digital photograph. The electronic device performs natural language processing on the text string to identify one or more terms associated with an entity, an activity, or a location. The electronic device tags the digital photograph with the one or more terms and their associated entity, activity, or location.

### RELATED APPLICATION

This application claims priority to U.S. Provisional Application Ser. No. 61/664,124, filed Jun. 25, 2012, which is incorporated herein by reference in its entirety.

### TECHNICAL FIELD

The disclosed implementations relate generally to digital assistant systems, and more specifically, to a method and system for voice-based image tagging and searching.

### BACKGROUND

Advances in camera technology, image processing and image storage technology have enabled humans to seamlessly interact with and “capture” their surroundings through digital photography. Moreover, recent advances in technology surrounding hand-held devices (e.g., mobile phones and digital assistant systems) have improved image capture and image storage capabilities on hand-held devices. This has led to a substantial increase in the use of hand-held devices for photo acquisition and digital photo storage.

The growing volume of digital photographs acquired and stored on electronic devices has created a need for systematic cataloging and efficient organization of the photographs in order to enable ease of viewing, searching, and organization of digital photographs. Tagging of photographs, for example, by associating with the photograph names of people or places, facilitates the ease of organizing and searching for photographs.

While photo capture and digital image storage technology has improved substantially over the past decade, traditional approaches to photo-tagging can be non-intuitive, arduous, and time-consuming.

### SUMMARY

Accordingly, there is a need for a simple, intuitive, user-friendly way to tag photographs. The present invention provides systems and methods for voice-based photo-tagging, automatic photo-tagging, and voice-based photo searching implemented at an electronic device.

Implementations described below provide a method and system of voice-based photo-tagging, automatic photo-tagging based on previously tagged photographs, and photo-searching through the use of natural language processing techniques. Natural language processing techniques are deployed to enable users to interact in spoken or textual forms with hand-held devices and digital assistant systems, whereby digital assistant systems can interpret the user's input to deduce the user's intent, translate the deduced intent into actionable tasks and parameters, execute operations or deploy services to perform the tasks, and produce output that is intelligible to the user.

Voice-based photo-tagging dramatically increases the speed and convenience of photo-tagging. For example, by combining speech recognition techniques with intelligent natural-language processing, the disclosed implementations enable users to simply speak a description of what is in a photograph, such as “this is me at the beach,” and the photo will be automatically tagged with the appropriate information. Moreover, because the natural-language processing is capable of inferring additional information, the tags may include additional information that the user did not explicitly say (such as the name of the person to which “me” refers), and which creates a more complete and useful tag. Once a photograph is tagged using the disclosed tagging techniques, other photographs that are similar may be automatically tagged with the same or similar information, thus obviating the need to tag every similar photograph individually. And when a user wishes to search among his photographs, he may simply speak a request: “show me photos of me at the beach.” The disclosed techniques are able to process this speech-based input in order to find and retrieve relevant photographs based on previously associated tags. Moreover, natural-language processing techniques are used to generate search queries from natural language utterances, where the utterance is not presented in a predefined search-query format, and which may contain ambiguous terms (e.g., pronouns “me,” “us,” etc.).

Thus, the implementations disclosed herein provide a complete photo interaction system, including methods, systems, and computer readable storage media that enable voice-based photo-tagging, automatic photo-tagging, and voice-based photo searching.

Some implementations provide a method for tagging or searching images using a voice-based digital assistant, including providing a digital photograph of a real-world scene; providing a natural language text string corresponding to a speech input associated with the digital photograph; performing natural language processing on the text string to identify one or more terms associated with an entity, an activity, or a location; and tagging the digital photograph with the one or more terms and their associated entity, activity, or location.

In some implementations, the entity is selected from an object or a person. In some implementations, the natural language processing includes determining whether each of the one or more terms in the text string is one of an entity, an activity, and a location. In some implementations, the natural language processing identifies two terms each associated with one of an entity, an activity, or a location, and the digital photograph is tagged with the two terms and their respective associated entity, activity, or location. In some implementations, a first of the two terms refers to a person, and a second of the two terms refers to a location. In some implementations, the natural language processing identifies three terms each associated with one of an entity, an activity, or a location, and the digital photograph is tagged with the three terms and their respective associated entity, activity, or location.

In some implementations, the method further includes receiving the speech input; and converting the speech input into the text string. In some implementations, the electronic device is a handheld electronic device; and the speech input is acquired at the handheld electronic device using one or more microphones.

In some implementations, the electronic device is a handheld electronic device; and providing the digital photograph comprises retrieving the digital photograph from a plurality of digital photographs stored on the handheld electronic device. In some implementations, the electronic device is a handheld electronic device; and providing the digital photograph includes capturing the digital photograph at the handheld electronic device using a camera.

In some implementations, the method further includes displaying, at a client device, the one or more terms on or near the digital photograph. In some implementations, the one or more terms are displayed on the digital photograph in spatial proximity to their corresponding entity, activity, or location.

In some implementations, the method further includes storing the one or more terms and their associated entity, activity, or location in association with at least one of the digital photograph or a representation of the digital photograph.

In some implementations, the natural language processing includes disambiguating ambiguous terms. In some implementations, disambiguating includes identifying that a first term of the one or more terms has multiple candidate meanings; prompting a user for additional information about the first term; receiving the additional information from the user in response to the prompt; and identifying the entity, activity, or location associated with the first term in accordance with the additional information. In some implementations, prompting the user for additional information includes providing a voice prompt to the user.

In some implementations, the natural language processing includes identifying one of the one or more terms as a pronoun; and determining a noun to which the pronoun refers. In some implementations, the noun is a name of an entity, an activity, or a location identified in a previous speech input associated with a previously tagged digital photograph. In some implementations, the noun is a name of a person identified using a contact list associated with a user of the electronic device. In some implementations, the noun is a name of a person identified based on a previous speech input associated with a previously tagged digital photograph.

In some implementations, the electronic device is a handheld electronic device; and performing the natural language processing on the text string further includes accessing information obtained from one or more sensors of the handheld electronic device for determining a meaning of one or more of the terms, wherein the one or more sensors are selected from the group consisting of: a proximity sensor, a light sensor, a GPS receiver, a temperature sensor, and an accelerometer.

In some implementations, the method includes providing an additional digital photograph; determining that the additional digital photograph is graphically similar to the digital photograph in one or more respects; and suggesting to a user that the additional digital photograph be tagged with the one or more terms and their associated entity, activity, or location identified with respect to the digital photograph. In some implementations, the method further includes receiving an input from the user indicating that the additional digital photograph should be tagged in accordance with the suggestion.

In some implementations, determining that the additional digital photograph is graphically similar to the digital photograph in one or more respects includes generating a first fingerprint of the digital photograph; generating a second fingerprint of the additional digital photograph; and determining that the first fingerprint and the second fingerprint match to within a predetermined threshold. In some implementations, the first fingerprint is a fingerprint of a graphical feature within the digital photograph, and the second fingerprint is a fingerprint of a graphical feature within the additional digital photograph.

Some implementations provide a method for auto-tagging images using a voice-based digital assistant, including obtaining a digital photograph of a real-world scene; generating a fingerprint of the digital photograph; identifying one or more reference fingerprints that correspond to the fingerprint; retrieving one or more tags associated with the reference fingerprints, wherein at least one of the tags includes a term and an associated entity, activity, or location; and associating the one or more tags with the digital photograph.

In some implementations, the one or more reference fingerprints correspond to photographs that were previously tagged by a user of the electronic device. In some implementations, the one or more reference fingerprints are from a repository containing fingerprints and tags from a plurality of users. In some implementations, the fingerprint is a fingerprint of a graphical feature within the digital photograph. In some implementations, associating the one or more tags with the digital photograph includes associating the one or more tags with the graphical feature within the digital photograph. In some implementations, the reference fingerprints are generated from reference digital photographs, and the reference digital photographs are associated with the one or more tags. In some implementations, the one or more reference fingerprints correspond to the fingerprint when they match the fingerprint to within a predetermined threshold.

In some implementations, the retrieved one or more tags includes two tags, each including a respective term and a respective entity, activity, or location, and wherein the two tags are associated with the digital photograph. In some implementations, a first of the two tags refers to a person, and a second of the two tags refers to a location. In some implementations, the retrieved one or more tags includes three tags, each including a respective term and a respective entity, activity, or location, and the three tags are associated with the digital photograph.

In some implementations, the method further includes, prior to obtaining the digital photograph, providing a first digital photograph; providing a natural language text string corresponding to a speech input associated with the first digital photograph; performing natural language processing on the text string to identify one or more terms associated with the entity, the activity, or the location; and tagging the first digital photograph with the one or more terms and their associated entity, activity, or location, wherein the reference fingerprint corresponds to the first digital photograph. In some implementations, the method further includes receiving the speech input; and converting the speech input into the text string.

In some implementations, the method further includes displaying, at a client device, each of the respective retrieved tags on or near the digital photograph. In some implementations, the respective retrieved tags are displayed on the digital photograph in spatial proximity to the respective features in the digital photograph.

In some implementations, the method further includes, prior to the associating, providing the one or more tags to a user; and obtaining a voice input from the user indicating that the one or more tags are associated with the digital photograph.

Some implementations provide a method for tagging or searching images using a voice-based digital assistant, including providing a natural language text string corresponding to a speech input; performing natural language processing on the text string, the natural language processing including: identifying a pronoun in the speech input and determining at least one name associated with the pronoun; generating a search query including the at least one name; identifying, from a collection of digital photographs, one or more digital photographs associated with a tag containing the at least one name; and providing, to a user, a representation of the one or more digital photographs.

In some implementations, the pronoun is the word “me,” and the name is a name of the user. In some implementations, the pronoun is the word “us,” and the name is a name of the user and another person.

In some implementations, performing the natural language processing further includes identifying one or more terms in the speech input that represent an entity, an activity, or a location, and wherein the search query further includes the terms corresponding to the entity, the activity, or the location.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods described herein.

In accordance with some implementations, an electronic device (e.g., a portable electronic device) is provided that comprises means for performing any of the methods described herein.

In accordance with some implementations, an electronic device (e.g., a portable electronic device) is provided that comprises a processing unit configured to perform any of the methods described herein.

In accordance with some implementations, an electronic device (e.g., a portable electronic device) is provided that comprises one or more processors and memory storing one or more programs for execution by the one or more processors, the one or more programs including instructions for performing any of the methods described herein.

In accordance with some implementations, an information processing apparatus for use in an electronic device is provided, the information processing apparatus comprising means for performing any of the methods described herein.

### BRIEF DESCRIPTION OF THE DRAWINGS

FIG. 1 is a block diagram illustrating an environment in which a digital assistant operates in accordance with some implementations.

FIG. 2 is a block diagram illustrating a digital assistant client system in accordance with some implementations.

FIG. 3A is a block diagram illustrating a standalone digital assistant system or a digital assistant server system in accordance with some implementations.

FIG. 3B is a block diagram illustrating functions of the digital assistant shown in FIG. 3A in accordance with some implementations.

FIG. 3C is a network diagram illustrating a portion of an ontology in accordance with some implementations.

FIGS. 4A-4E are flow charts illustrating a method for tagging digital photographs based on speech input, in accordance with some implementations.

FIGS. 5A-5B are flow charts illustrating another method for tagging digital photographs based on speech input, in accordance with some implementations.

FIG. 6 is a flow chart illustrating a method for searching digital photographs based on speech input, in accordance with some implementations.

Like reference numerals refer to corresponding parts throughout the drawings.

### DESCRIPTION OF IMPLEMENTATIONS

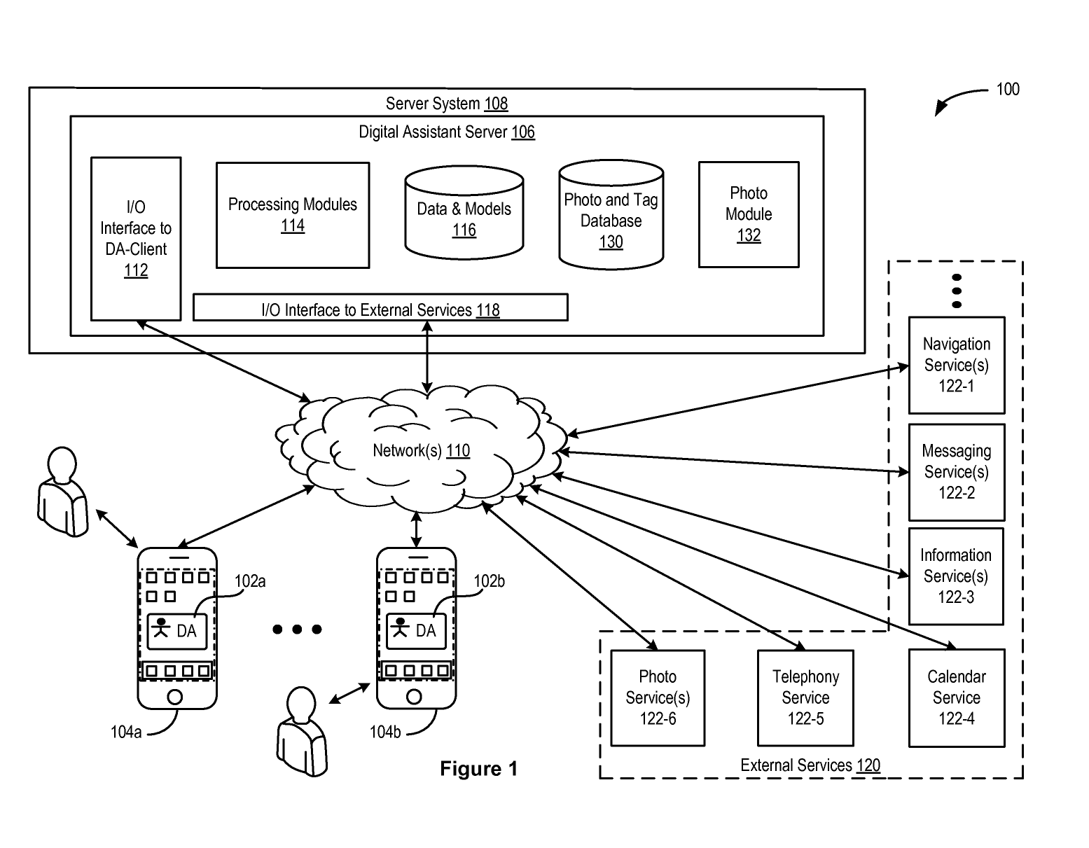

FIG. 1 is a block diagram of an operating environment 100 of a digital assistant according to some implementations. The terms “digital assistant,” “virtual assistant,” “intelligent automated assistant,” or “automatic digital assistant,” refer to any information processing system that interprets natural language input in spoken and/or textual form to deduce user intent (e.g., identify a task type that corresponds to the natural language input), and performs actions based on the deduced user intent (e.g., perform a task corresponding to the identified task type). For example, to act on a deduced user intent, the system can perform one or more of the following: identifying a task flow with steps and parameters designed to accomplish the deduced user intent (e.g., identifying a task type), inputting specific requirements from the deduced user intent into the task flow, executing the task flow by invoking programs, methods, services, APIs, or the like (e.g., sending a request to a service provider); and generating output responses to the user in an audible (e.g., speech) and/or visual form.

Specifically, a digital assistant system is capable of accepting a user request at least partially in the form of a natural language command, request, statement, narrative, and/or inquiry. Typically, the user request seeks either an informational answer or performance of a task by the digital assistant system. A satisfactory response to the user request is generally either provision of the requested informational answer, performance of the requested task, or a combination of the two. For example, a user may ask the digital assistant system a question, such as “Where am I right now?” Based on the user's current location, the digital assistant may answer, “You are in Central Park near the west gate.” The user may also request the performance of a task, for example, by stating “Please invite my friends to my girlfriend's birthday party next week.” In response, the digital assistant may acknowledge the request by generating a voice output, “Yes, right away,” and then send a suitable calendar invite from the user's email address to each of the user' friends listed in the user's electronic address book or contact list. There are numerous other ways of interacting with a digital assistant to request information or performance of various tasks. In addition to providing verbal responses and taking programmed actions, the digital assistant can also provide responses in other visual or audio forms (e.g., as text, alerts, music, videos, animations, etc.).

As shown in FIG. 1, in some implementations, a digital assistant system is implemented according to a client-server model. The digital assistant system includes a client-side portion (e.g., 102a and 102b) (hereafter “digital assistant (DA) client 102”) executed on a user device (e.g., 104a and 104b), and a server-side portion 106 (hereafter “digital assistant (DA) server 106”) executed on a server system 108. The DA client 102 communicates with the DA server 106 through one or more networks 110. The DA client 102 provides client-side functionalities such as user-facing input and output processing and communications with the DA server 106. The DA server 106 provides server-side functionalities for any number of DA clients 102 each residing on a respective user device 104 (also called a client device).

In some implementations, the DA server 106 includes a client-facing I/O interface 112, one or more processing modules 114, data and models 116, an I/O interface to external services 118, a photo and tag database 130, and a photo-tag module 132. The client-facing I/O interface facilitates the client-facing input and output processing for the digital assistant server 106. The one or more processing modules 114 utilize the data and models 116 to determine the user's intent based on natural language input and perform task execution based on the deduced user intent. Photo and tag database 130 stores fingerprints of digital photographs, and, optionally digital photographs themselves, as well as tags associated with the digital photographs. Photo-tag module 132 creates tags, stores tags in association with photographs and/or fingerprints, automatically tags photographs, and links tags to locations within photographs.

In some implementations, the DA server 106 communicates with external services 120 (e.g., navigation service(s) 122-1, messaging service(s) 122-2, information service(s) 122-3, calendar service 122-4, telephony service 122-5, photo service(s) 122-6, etc.) through the network(s) 110 for task completion or information acquisition. The I/O interface to the external services 118 facilitates such communications.

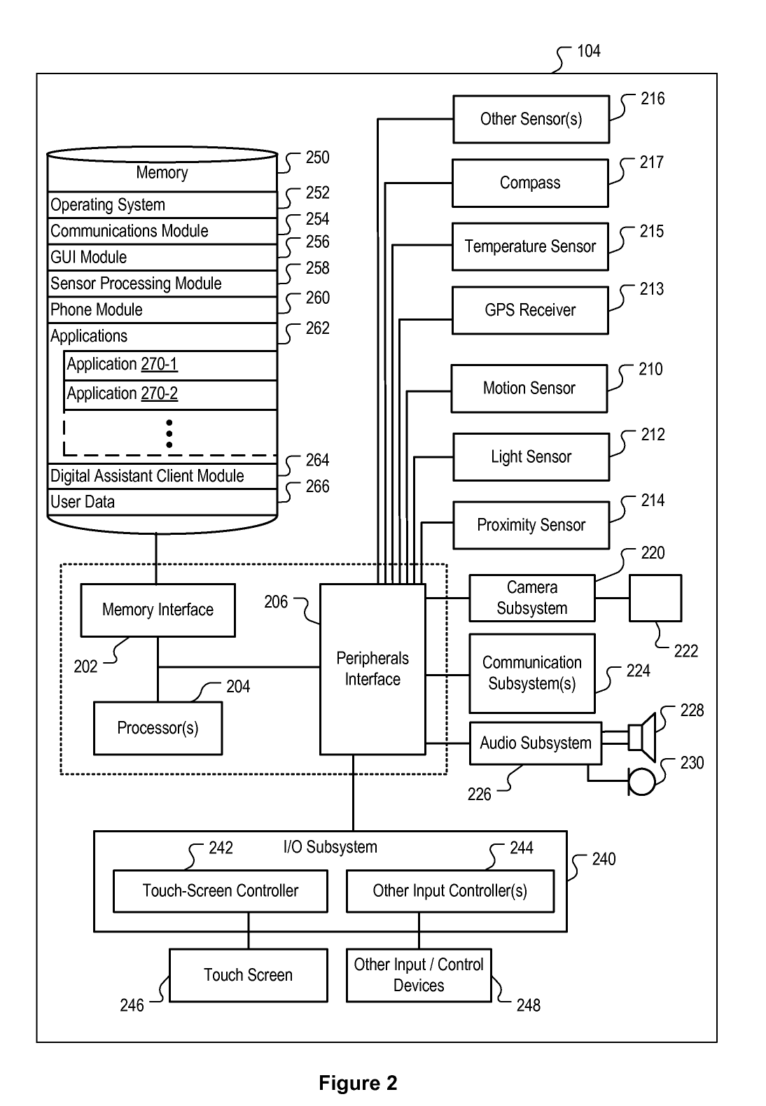

Examples of the user device 104 include, but are not limited to, a handheld computer, a personal digital assistant (PDA), a tablet computer, a laptop computer, a desktop computer, a cellular telephone, a smartphone, an enhanced general packet radio service (EGPRS) mobile phone, a media player, a navigation device, a game console, a television, a remote control, or a combination of any two or more of these data processing devices or any other suitable data processing devices. More details on the user device 104 are provided in reference to an exemplary user device 104 shown in FIG. 2.

Examples of the communication network(s) 110 include local area networks (“LAN”) and wide area networks (“WAN”), e.g., the Internet. The communication network(s) 110 may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

The server system 108 can be implemented on at least one data processing apparatus and/or a distributed network of computers. In some implementations, the server system 108 also employs various virtual devices and/or services of third party service providers (e.g., third-party cloud service providers) to provide the underlying computing resources and/or infrastructure resources of the server system 108.

Although the digital assistant system shown in FIG. 1 includes both a client-side portion (e.g., the DA client 102) and a server-side portion (e.g., the DA server 106), in some implementations, a digital assistant system refers only to the server-side portion (e.g., the DA server 106). In some implementations, the functions of a digital assistant can be implemented as a standalone application installed on a user device. In addition, the divisions of functionalities between the client and server portions of the digital assistant can vary in different implementations. For example, in some implementations, the DA client 102 is a thin-client that provides only user-facing input and output processing functions, and delegates all other functionalities of the digital assistant to the DA server 106. In some other implementations, the DA client 102 is configured to perform or assist one or more functions of the DA server 106.

FIG. 2 is a block diagram of a user device 104 in accordance with some implementations. The user device 104 includes a memory interface 202, one or more processors 204, and a peripherals interface 206. The various components in the user device 104 are coupled by one or more communication buses or signal lines. The user device 104 includes various sensors, subsystems, and peripheral devices that are coupled to the peripherals interface 206. The sensors, subsystems, and peripheral devices gather information and/or facilitate various functionalities of the user device 104.

For example, in some implementations, a motion sensor 210 (e.g., an accelerometer), a light sensor 212, a GPS receiver 213, a temperature sensor, and a proximity sensor 214 are coupled to the peripherals interface 206 to facilitate orientation, light, and proximity sensing functions. In some implementations, other sensors 216, such as a biometric sensor, barometer, and the like, are connected to the peripherals interface 206, to facilitate related functionalities.

In some implementations, the user device 104 includes a camera subsystem 220 coupled to the peripherals interface 206. In some implementations, an optical sensor 222 of the camera subsystem 220 facilitates camera functions, such as taking photographs and recording video clips. In some implementations, the user device 104 includes one or more wired and/or wireless communication subsystems 224 provide communication functions. The communication subsystems 224 typically includes various communication ports, radio frequency receivers and transmitters, and/or optical (e.g., infrared) receivers and transmitters. In some implementations, the user device 104 includes an audio subsystem 226 coupled to one or more speakers 228 and one or more microphones 230 to facilitate voice-enabled functions, such as voice recognition, voice replication, digital recording, and telephony functions.

In some implementations, an I/O subsystem 240 is also coupled to the peripheral interface 206. In some implementations, the user device 104 includes a touch screen 246, and the I/O subsystem 240 includes a touch screen controller 242 coupled to the touch screen 246. When the user device 104 includes the touch screen 246 and the touch screen controller 242, the touch screen 246 and the touch screen controller 242 are typically configured to, for example, detect contact and movement or break thereof using any of a plurality of touch sensitivity technologies, such as capacitive, resistive, infrared, surface acoustic wave technologies, proximity sensor arrays, and the like. In some implementations, the user device 104 includes a display that does not include a touch-sensitive surface. In some implementations, the user device 104 includes a separate touch-sensitive surface. In some implementations, the user device 104 includes other input controller(s) 244. When the user device 104 includes the other input controller(s) 244, the other input controller(s) 244 are typically coupled to other input/control devices 248, such as one or more buttons, rocker switches, thumb-wheel, infrared port, USB port, and/or a pointer device such as a stylus.

The memory interface 202 is coupled to memory 250. In some implementations, memory 250 includes a non-transitory computer readable medium, such as high-speed random access memory and/or non-volatile memory (e.g., one or more magnetic disk storage devices, one or more flash memory devices, one or more optical storage devices, and/or other non-volatile solid-state memory devices).

In some implementations, memory 250 stores an operating system 252, a communications module 254, a graphical user interface module 256, a sensor processing module 258, a phone module 260, and applications 262, and a subset or superset thereof. The operating system 252 includes instructions for handling basic system services and for performing hardware dependent tasks. The communications module 254 facilitates communicating with one or more additional devices, one or more computers and/or one or more servers. The graphical user interface module 256 facilitates graphic user interface processing. The sensor processing module 258 facilitates sensor-related processing and functions (e.g., processing voice input received with the one or more microphones 228). The phone module 260 facilitates phone-related processes and functions. The application module 262 facilitates various functionalities of user applications, such as electronic-messaging, web browsing, media processing, navigation, imaging and/or other processes and functions. In some implementations, the user device 104 stores in memory 250 one or more software applications 270-1 and 270-2 each associated with at least one of the external service providers.

As described above, in some implementations, memory 250 also stores client-side digital assistant instructions (e.g., in a digital assistant client module 264) and various user data 266 (e.g., user-specific vocabulary data, preference data, and/or other data such as the user's electronic address book or contact list, to-do lists, shopping lists, etc.) to provide the client-side functionalities of the digital assistant.

In various implementations, the digital assistant client module 264 is capable of accepting voice input, text input, touch input, and/or gestural input through various user interfaces (e.g., the I/O subsystem 244) of the user device 104. The digital assistant client module 264 is also capable of providing output in audio, visual, and/or tactile forms. For example, output can be provided as voice, sound, alerts, text messages, menus, graphics, videos, animations, vibrations, and/or combinations of two or more of the above. During operation, the digital assistant client module 264 communicates with the digital assistant server (e.g., the digital assistant server 106, FIG. 1) using the communication subsystems 224.

In some implementations, the digital assistant client module 264 utilizes various sensors, subsystems and peripheral devices to gather additional information from the surrounding environment of the user device 104 to establish a context associated with a user input. In some implementations, the digital assistant client module 264 provides the context information or a subset thereof with the user input to the digital assistant server (e.g., the digital assistant server 106, FIG. 1) to help deduce the user's intent.

In some implementations, the context information that can accompany the user input includes sensor information, e.g., lighting, ambient noise, ambient temperature, images or videos of the surrounding environment, etc. In some implementations, the context information also includes the physical state of the device, e.g., device orientation, device location, device temperature, power level, speed, acceleration, motion patterns, cellular signals strength, etc. In some implementations, information related to the software state of the user device 106, e.g., running processes, installed programs, past and present network activities, background services, error logs, resources usage, etc., of the user device 104 is also provided to the digital assistant server (e.g., the digital assistant server 106, FIG. 1) as context information associated with a user input.

In some implementations, the DA client module 264 selectively provides information (e.g., at least a portion of the user data 266) stored on the user device 104 in response to requests from the digital assistant server. In some implementations, the digital assistant client module 264 also elicits additional input from the user via a natural language dialogue or other user interfaces upon request by the digital assistant server 106 (FIG. 1). The digital assistant client module 264 passes the additional input to the digital assistant server 106 to help the digital assistant server 106 in intent deduction and/or fulfillment of the user's intent expressed in the user request.

In some implementations, memory 250 may include additional instructions or fewer instructions. Furthermore, various functions of the user device 104 may be implemented in hardware and/or in firmware, including in one or more signal processing and/or application specific integrated circuits, and the user device 104, thus, need not include all modules and applications illustrated in FIG. 2.

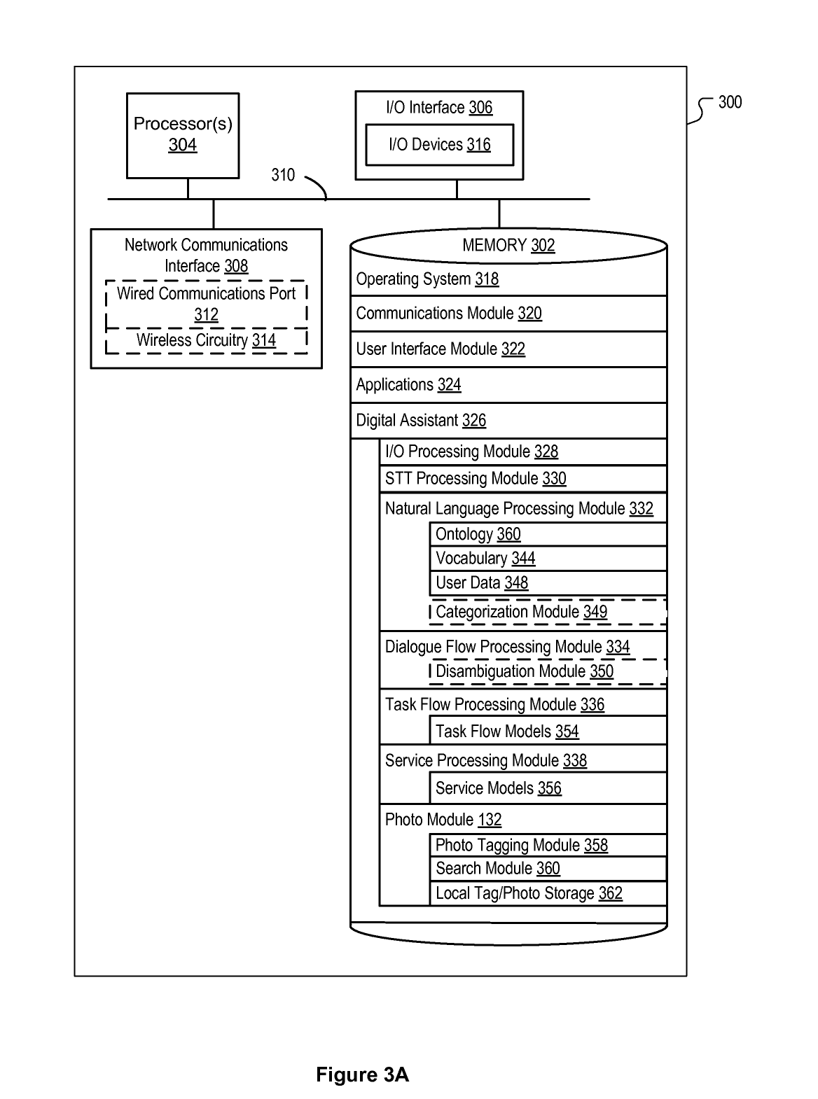

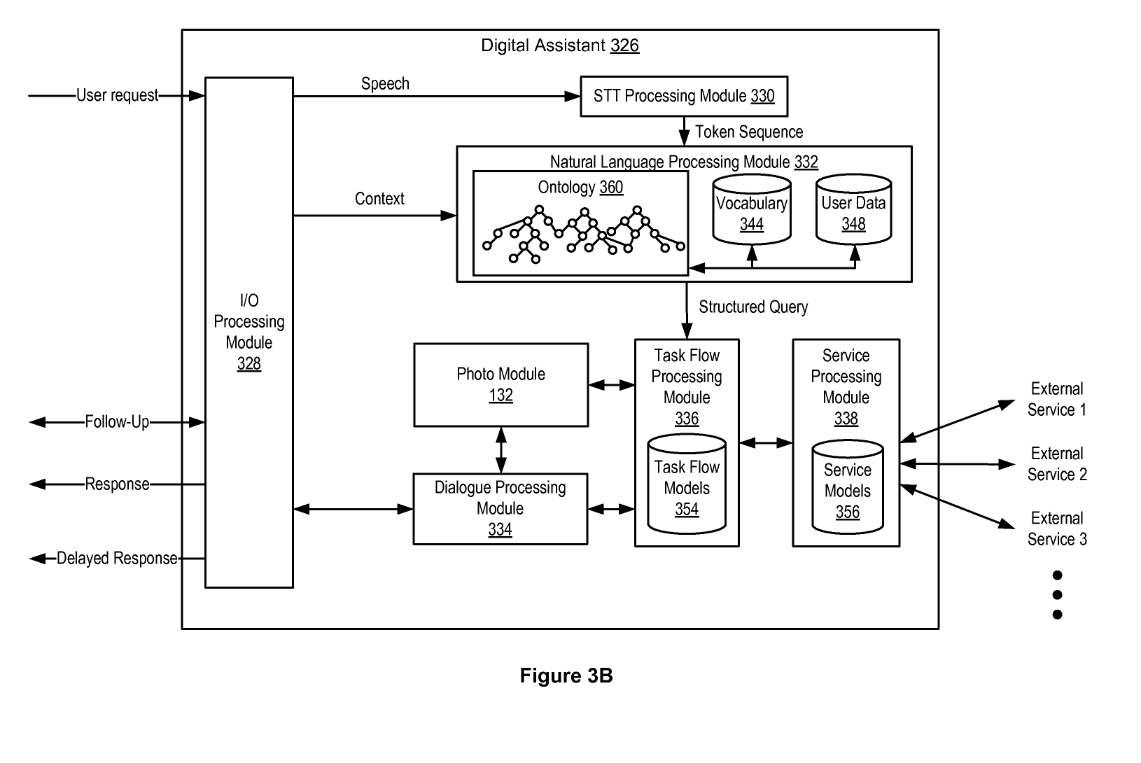

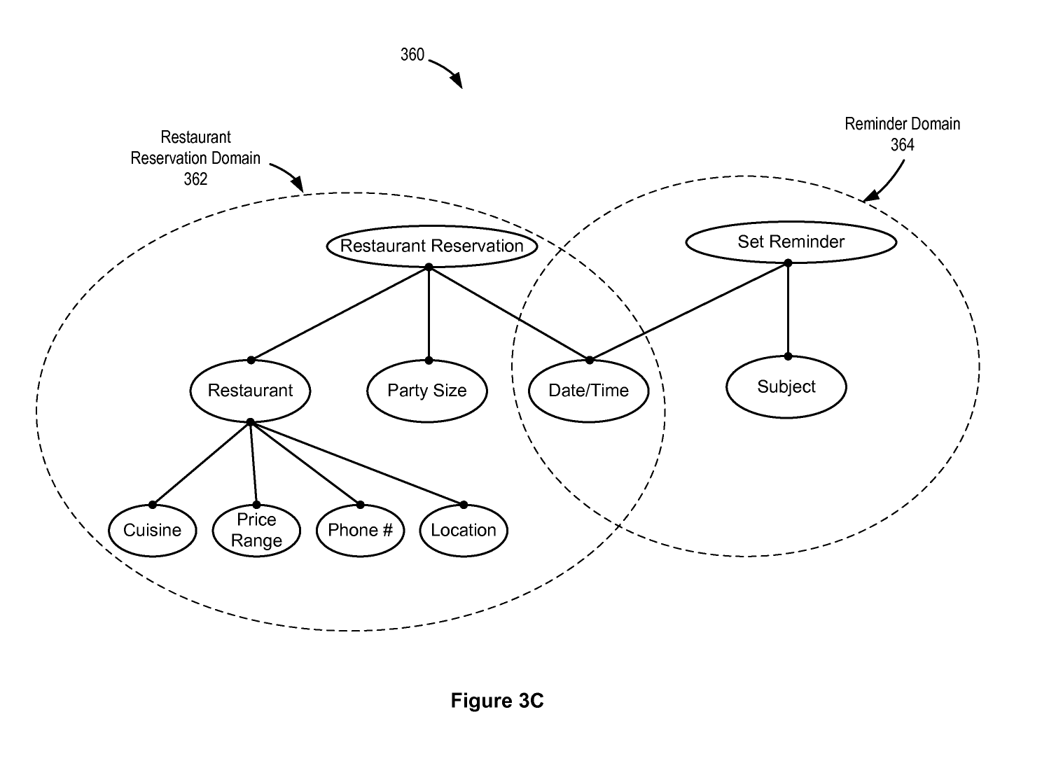

FIG. 3A is a block diagram of an exemplary digital assistant system 300 (also referred to as the digital assistant) in accordance with some implementations. In some implementations, the digital assistant system 300 is implemented on a standalone computer system. In some implementations, the digital assistant system 300 is distributed across multiple computers. In some implementations, some of the modules and functions of the digital assistant are divided into a server portion and a client portion, where the client portion resides on a user device (e.g., the user device 104) and communicates with the server portion (e.g., the server system 108) through one or more networks, e.g., as shown in FIG. 1. In some implementations, the digital assistant system 300 is an embodiment of the server system 108 (and/or the digital assistant server 106) shown in FIG. 1. In some implementations, the digital assistant system 300 is implemented in a user device (e.g., the user device 104, FIG. 1), thereby eliminating the need for a client-server system. It should be noted that the digital assistant system 300 is only one example of a digital assistant system, and that the digital assistant system 300 may have more or fewer components than shown, may combine two or more components, or may have a different configuration or arrangement of the components. The various components shown in FIG. 3A may be implemented in hardware, software, firmware, including one or more signal processing and/or application specific integrated circuits, or a combination of thereof.

The digital assistant system 300 includes memory 302, one or more processors 304, an input/output (I/O) interface 306, and a network communications interface 308. These components communicate with one another over one or more communication buses or signal lines 310.

In some implementations, memory 302 includes a non-transitory computer readable medium, such as high-speed random access memory and/or a non-volatile computer readable storage medium (e.g., one or more magnetic disk storage devices, one or more flash memory devices, one or more optical storage devices, and/or other non-volatile solid-state memory devices).

The I/O interface 306 couples input/output devices 316 of the digital assistant system 300, such as displays, a keyboards, touch screens, and microphones, to the user interface module 322. The I/O interface 306, in conjunction with the user interface module 322, receives user inputs (e.g., voice input, keyboard inputs, touch inputs, etc.) and process them accordingly. In some implementations, when the digital assistant is implemented on a standalone user device, the digital assistant system 300 includes any of the components and I/O and communication interfaces described with respect to the user device 104 in FIG. 2 (e.g., one or more microphones 230). In some implementations, the digital assistant system 300 represents the server portion of a digital assistant implementation, and interacts with the user through a client-side portion residing on a user device (e.g., the user device 104 shown in FIG. 2).

In some implementations, the network communications interface 308 includes wired communication port(s) 312 and/or wireless transmission and reception circuitry 314. The wired communication port(s) receive and send communication signals via one or more wired interfaces, e.g., Ethernet, Universal Serial Bus (USB), FIREWIRE, etc. The wireless circuitry 314 typically receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 308 enables communication between the digital assistant system 300 with networks, such as the Internet, an intranet and/or a wireless network, such as a cellular telephone network, a wireless local area network (LAN) and/or a metropolitan area network (MAN), and other devices.

In some implementations, the non-transitory computer readable storage medium of memory 302 stores programs, modules, instructions, and data structures including all or a subset of: an operating system 318, a communications module 320, a user interface module 322, one or more applications 324, and a digital assistant module 326. The one or more processors 304 execute these programs, modules, and instructions, and reads/writes from/to the data structures.

The operating system 318 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

The communications module 320 facilitates communications between the digital assistant system 300 with other devices over the network communications interface 308. For example, the communication module 320 may communicate with the communications module 254 of the device 104 shown in FIG. 2. The communications module 320 also includes various software components for handling data received by the wireless circuitry 314 and/or wired communications port 312.

In some implementations, the user interface module 322 receives commands and/or inputs from a user via the I/O interface 306 (e.g., from a keyboard, touch screen, and/or microphone), and provides user interface objects on a display.

The applications 324 include programs and/or modules that are configured to be executed by the one or more processors 304. For example, if the digital assistant system is implemented on a standalone user device, the applications 324 may include user applications, such as games, a calendar application, a navigation application, or an email application. If the digital assistant system 300 is implemented on a server farm, the applications 324 may include resource management applications, diagnostic applications, or scheduling applications, for example.

Memory 302 also stores the digital assistant module (or the server portion of a digital assistant) 326. In some implementations, the digital assistant module 326 includes the following sub-modules, or a subset or superset thereof: an input/output processing module 328, a speech-to-text (STT) processing module 330, a natural language processing module 332, a dialogue flow processing module 334, a task flow processing module 336, a service processing module 338, and a photo module 132. Each of these processing modules has access to one or more of the following data and models of the digital assistant 326, or a subset or superset thereof: ontology 360, vocabulary index 344, user data 348, categorization module 349, disambiguation module 350, task flow models 354, service models 356, photo tagging module 358, search module 360, and local tag/photo storage 362.

In some implementations, using the processing modules (e.g., the input/output processing module 328, the STT processing module 330, the natural language processing module 332, the dialogue flow processing module 334, the task flow processing module 336, and/or the service processing module 338), data, and models implemented in the digital assistant module 326, the digital assistant system 300 performs at least some of the following: identifying a user's intent expressed in a natural language input received from the user; actively eliciting and obtaining information needed to fully deduce the user's intent (e.g., by disambiguating words, names, intentions, etc.); determining the task flow for fulfilling the deduced intent; and executing the task flow to fulfill the deduced intent. In some implementations, the digital assistant also takes appropriate actions when a satisfactory response was not or could not be provided to the user for various reasons.

In some implementations, as discussed below, the digital assistant system 300 identifies, from a natural language input, a user's intent to tag a digital photograph, and processes the natural language input so as to tag the digital photograph with appropriate information. In some implementations, the digital assistant system 300 performs other tasks related to photographs as well, such as searching for digital photographs using natural language input, auto-tagging photographs, and the like.

As shown in FIG. 3B, in some implementations, the I/O processing module 328 interacts with the user through the I/O devices 316 in FIG. 3A or with a user device (e.g., a user device 104 in FIG. 1) through the network communications interface 308 in FIG. 3A to obtain user input (e.g., a speech input) and to provide responses to the user input. The I/O processing module 328 optionally obtains context information associated with the user input from the user device, along with or shortly after the receipt of the user input. The context information includes user-specific data, vocabulary, and/or preferences relevant to the user input. In some implementations, the context information also includes software and hardware states of the device (e.g., the user device 104 in FIG. 1) at the time the user request is received, and/or information related to the surrounding environment of the user at the time that the user request was received. In some implementations, the I/O processing module 328 also sends follow-up questions to, and receives answers from, the user regarding the user request. In some implementations, when a user request is received by the I/O processing module 328 and the user request contains a speech input, the I/O processing module 328 forwards the speech input to the speech-to-text (STT) processing module 330 for speech-to-text conversions.

In some implementations, the speech-to-text processing module 330 receives speech input (e.g., a user utterance captured in a voice recording) through the I/O processing module 328. In some implementations, the speech-to-text processing module 330 uses various acoustic and language models to recognize the speech input as a sequence of phonemes, and ultimately, a sequence of words or tokens written in one or more languages. The speech-to-text processing module 330 is implemented using any suitable speech recognition techniques, acoustic models, and language models, such as Hidden Markov Models, Dynamic Time Warping (DTW)-based speech recognition, and other statistical and/or analytical techniques. In some implementations, the speech-to-text processing can be performed at least partially by a third party service or on the user's device. Once the speech-to-text processing module 330 obtains the result of the speech-to-text processing (e.g., a sequence of words or tokens), it passes the result to the natural language processing module 332 for intent deduction.

The natural language processing module 332 (“natural language processor”) of the digital assistant 326 takes the sequence of words or tokens (“token sequence”) generated by the speech-to-text processing module 330, and attempts to associate the token sequence with one or more “actionable intents” recognized by the digital assistant. As used herein, an “actionable intent” represents a task that can be performed by the digital assistant 326 and/or the digital assistant system 300 (FIG. 3A), and has an associated task flow implemented in the task flow models 354. The associated task flow is a series of programmed actions and steps that the digital assistant system 300 takes in order to perform the task. The scope of a digital assistant system's capabilities is dependent on the number and variety of task flows that have been implemented and stored in the task flow models 354, or in other words, on the number and variety of “actionable intents” that the digital assistant system 300 recognizes. The effectiveness of the digital assistant system 300, however, is also dependent on the digital assistant system's ability to deduce the correct “actionable intent(s)” from the user request expressed in natural language.

In some implementations, in addition to the sequence of words or tokens obtained from the speech-to-text processing module 330, the natural language processor 332 also receives context information associated with the user request (e.g., from the I/O processing module 328). The natural language processor 332 optionally uses the context information to clarify, supplement, and/or further define the information contained in the token sequence received from the speech-to-text processing module 330. The context information includes, for example, user preferences, hardware and/or software states of the user device, sensor information collected before, during, or shortly after the user request, prior interactions (e.g., dialogue) between the digital assistant and the user, and the like.

In some implementations, the natural language processing is based on an ontology 360. The ontology 360 is a hierarchical structure containing a plurality of nodes, each node representing either an “actionable intent” or a “property” relevant to one or more of the “actionable intents” or other “properties.” As noted above, an “actionable intent” represents a task that the digital assistant system 300 is capable of performing (e.g., a task that is “actionable” or can be acted on). A “property” represents a parameter associated with an actionable intent or a sub-aspect of another property. A linkage between an actionable intent node and a property node in the ontology 360 defines how a parameter represented by the property node pertains to the task represented by the actionable intent node.

In some implementations, the ontology 360 is made up of actionable intent nodes and property nodes. Within the ontology 360, each actionable intent node is linked to one or more property nodes either directly or through one or more intermediate property nodes. Similarly, each property node is linked to one or more actionable intent nodes either directly or through one or more intermediate property nodes. For example, the ontology 360 shown in FIG. 3C includes a “restaurant reservation” node, which is an actionable intent node. Property nodes “restaurant,” “date/time” (for the reservation), and “party size” are each directly linked to the “restaurant reservation” node (i.e., the actionable intent node). In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, the ontology 360 shown in FIG. 3C also includes a “set reminder” node, which is another actionable intent node. Property nodes “date/time” (for the setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in the ontology 360.

An actionable intent node, along with its linked concept nodes, may be described as a “domain.” In the present discussion, each domain is associated with a respective actionable intent, and refers to the group of nodes (and the relationships therebetween) associated with the particular actionable intent. For example, the ontology 360 shown in FIG. 3C includes an example of a restaurant reservation domain 362 and an example of a reminder domain 364 within the ontology 360. The restaurant reservation domain includes the actionable intent node “restaurant reservation,” property nodes “restaurant,” “date/time,” and “party size,” and sub-property nodes “cuisine,” “price range,” “phone number,” and “location.” The reminder domain 364 includes the actionable intent node “set reminder,” and property nodes “subject” and “date/time.” In some implementations, the ontology 360 is made up of many domains. Each domain may share one or more property nodes with one or more other domains. For example, the “date/time” property node may be associated with many other domains (e.g., a scheduling domain, a travel reservation domain, a movie ticket domain, etc.), in addition to the restaurant reservation domain 362 and the reminder domain 364.

While FIG. 3C illustrates two exemplary domains within the ontology 360, the ontology 360 may include other domains (or actionable intents), such as “initiate a phone call,” “find directions,” “schedule a meeting,” “send a message,” and “provide an answer to a question,” “tag a photo,” and so on. For example, a “send a message” domain is associated with a “send a message” actionable intent node, and may further include property nodes such as “recipient(s),” “message type,” and “message body.” The property node “recipient” may be further defined, for example, by the sub-property nodes such as “recipient name” and “message address.”

In some implementations, the ontology 360 includes all the domains (and hence actionable intents) that the digital assistant is capable of understanding and acting upon. In some implementations, the ontology 360 may be modified, such as by adding or removing domains or nodes, or by modifying relationships between the nodes within the ontology 360.

In some implementations, nodes associated with multiple related actionable intents may be clustered under a “super domain” in the ontology 360. For example, a “travel” super-domain may include a cluster of property nodes and actionable intent nodes related to travels. The actionable intent nodes related to travels may include “airline reservation,” “hotel reservation,” “car rental,” “get directions,” “find points of interest,” and so on. The actionable intent nodes under the same super domain (e.g., the “travels” super domain) may have many property nodes in common. For example, the actionable intent nodes for “airline reservation,” “hotel reservation,” “car rental,” “get directions,” “find points of interest” may share one or more of the property nodes “start location,” “destination,” “departure date/time,” “arrival date/time,” and “party size.”

In some implementations, each node in the ontology 360 is associated with a set of words and/or phrases that are relevant to the property or actionable intent represented by the node. The respective set of words and/or phrases associated with each node is the so-called “vocabulary” associated with the node. The respective set of words and/or phrases associated with each node can be stored in the vocabulary index 344 (FIG. 3B) in association with the property or actionable intent represented by the node. For example, returning to FIG. 3B, the vocabulary associated with the node for the property of “restaurant” may include words such as “food,” “drinks,” “cuisine,” “hungry,” “eat,” “pizza,” “fast food,” “meal,” and so on. For another example, the vocabulary associated with the node for the actionable intent of “initiate a phone call” may include words and phrases such as “call,” “phone,” “dial,” “ring,” “call this number,” “make a call to,” and so on. The vocabulary index 344 optionally includes words and phrases in different languages.

In some implementations, the natural language processor 332 shown in FIG. 3B receives the token sequence (e.g., a text string) from the speech-to-text processing module 330, and determines what nodes are implicated by the words in the token sequence. In some implementations, if a word or phrase in the token sequence is found to be associated with one or more nodes in the ontology 360 (via the vocabulary index 344), the word or phrase will “trigger” or “activate” those nodes. When multiple nodes are “triggered,” based on the quantity and/or relative importance of the activated nodes, the natural language processor 332 will select one of the actionable intents as the task (or task type) that the user intended the digital assistant to perform. In some implementations, the domain that has the most “triggered” nodes is selected. In some implementations, the domain having the highest confidence value (e.g., based on the relative importance of its various triggered nodes) is selected. In some implementations, the domain is selected based on a combination of the number and the importance of the triggered nodes. In some implementations, additional factors are considered in selecting the node as well, such as whether the digital assistant system 300 has previously correctly interpreted a similar request from a user.

In some implementations, the digital assistant system 300 also stores names of specific entities in the vocabulary index 344, so that when one of these names is detected in the user request, the natural language processor 332 will be able to recognize that the name refers to a specific instance of a property or sub-property in the ontology. In some implementations, the names of specific entities are names of businesses, restaurants, people, movies, and the like. In some implementations, the digital assistant system 300 can search and identify specific entity names from other data sources, such as the user's address book or contact list, a movies database, a musicians database, and/or a restaurant database. In some implementations, when the natural language processor 332 identifies that a word in the token sequence is a name of a specific entity (such as a name in the user's address book or contact list), that word is given additional significance in selecting the actionable intent within the ontology for the user request.

For example, when the words “Mr. Santo” are recognized from the user request, and the last name “Santo” is found in the vocabulary index 344 as one of the contacts in the user's contact list, then it is likely that the user request corresponds to a “send a message” or “initiate a phone call” domain. For another example, when the words “ABC Café” are found in the user request, and the term “ABC Café” is found in the vocabulary index 344 as the name of a particular restaurant in the user's city, then it is likely that the user request corresponds to a “restaurant reservation” domain.

User data 348 includes user-specific information, such as user-specific vocabulary, user preferences, user address, user's default and secondary languages, user's contact list, and other short-term or long-term information for each user. The natural language processor 332 can use the user-specific information to supplement the information contained in the user input to further define the user intent. For example, for a user request “invite my friends to my birthday party,” the natural language processor 332 is able to access user data 348 to determine who the “friends” are and when and where the “birthday party” would be held, rather than requiring the user to provide such information explicitly in his/her request.

In some implementations, natural language processor 332 includes categorization module 349. In some implementations, the categorization module 349 determines whether each of the one or more terms in a text string (e.g., corresponding to a speech input associated with a digital photograph) is one of an entity, an activity, or a location, as discussed in greater detail below. In some implementations, the categorization module 349 classifies each term of the one or more terms as one of an entity, an activity, or a location.

Once the natural language processor 332 identifies an actionable intent (or domain) based on the user request, the natural language processor 332 generates a structured query to represent the identified actionable intent. In some implementations, the structured query includes parameters for one or more nodes within the domain for the actionable intent, and at least some of the parameters are populated with the specific information and requirements specified in the user request. For example, the user may say “Make me a dinner reservation at a sushi place at 7.” In this case, the natural language processor 332 may be able to correctly identify the actionable intent to be “restaurant reservation” based on the user input. According to the ontology, a structured query for a “restaurant reservation” domain may include parameters such as {Cuisine}, {Time}, {Date}, {Party Size}, and the like. Based on the information contained in the user's utterance, the natural language processor 332 may generate a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some implementations, the natural language processor 332 populates some parameters of the structured query with received context information. For example, if the user requested a sushi restaurant “near me,” the natural language processor 332 may populate a {location} parameter in the structured query with GPS coordinates from the user device 104.

In some implementations, the natural language processor 332 passes the structured query (including any completed parameters) to the task flow processing module 336 (“task flow processor”). The task flow processor 336 is configured to perform one or more of: receiving the structured query from the natural language processor 332, completing the structured query, and performing the actions required to “complete” the user's ultimate request. In some implementations, the various procedures necessary to complete these tasks are provided in task flow models 354. In some implementations, the task flow models 354 include procedures for obtaining additional information from the user, and task flows for performing actions associated with the actionable intent.

As described above, in order to complete a structured query, the task flow processor 336 may need to initiate additional dialogue with the user in order to obtain additional information, and/or disambiguate potentially ambiguous utterances. When such interactions are necessary, the task flow processor 336 invokes the dialogue processing module 334 (“dialogue processor”) to engage in a dialogue with the user. In some implementations, the dialogue processing module 334 determines how (and/or when) to ask the user for the additional information, and receives and processes the user responses. In some implementations, the questions are provided to and answers are received from the users through the I/O processing module 328. For example, the dialogue processing module 334 presents dialogue output to the user via audio and/or visual output, and receives input from the user via spoken or physical (e.g., touch gesture) responses. Continuing with the example above, when the task flow processor 336 invokes the dialogue processor 334 to determine the “party size” and “date” information for the structured query associated with the domain “restaurant reservation,” the dialogue processor 334 generates questions such as “For how many people?” and “On which day?” to pass to the user. Once answers are received from the user, the dialogue processing module 334 populates the structured query with the missing information, or passes the information to the task flow processor 336 to complete the missing information from the structured query.

In some cases, the task flow processor 336 may receive a structured query that has one or more ambiguous properties. For example, a structured query for the “send a message” domain may indicate that the intended recipient is “Bob,” and the user may have multiple contacts named “Bob.” The task flow processor 336 will request that the dialogue processor 334 disambiguate this property of the structured query. In turn, the dialogue processor 334 may ask the user “Which Bob?”, and display (or read) a list of contacts named “Bob” from which the user may choose.

In some implementations, dialogue processor 334 includes disambiguation module 350. In some implementations, disambiguation module 350 disambiguates one or more ambiguous terms (e.g., one or more ambiguous terms in a text string corresponding to a speech input associated with a digital photograph). In some implementations, disambiguation module 350 identifies that a first term of the one or more terms has multiple candidate meanings, prompts a user for additional information about the first term, receives the additional information from the user in response to the prompt and identifies the entity, activity, or location associated with the first term in accordance with the additional information.

In some implementations, disambiguation module 350 disambiguates pronouns. In such implementations, disambiguation module 350 identifies one of the one or more terms as a pronoun and determines a noun to which the pronoun refers. In some implementations, disambiguation module 350 determines a noun to which the pronoun refers by using a contact list associated with a user of the electronic device. Alternatively, or in addition, disambiguation module 350 determines a noun to which the pronoun refers as a name of an entity, an activity, or a location identified in a previous speech input associated with a previously tagged digital photograph. Alternatively, or in addition, disambiguation module 350 determines a noun to which the pronoun refers as a name of a person identified based on a previous speech input associated with a previously tagged digital photograph.

In some implementations, disambiguation module 350 accesses information obtained from one or more sensors (e.g., proximity sensor 214, light sensor 212, GPS receiver 213, temperature sensor 215, and motion sensor 210) of a handheld electronic device (e.g., user device 104) for determining a meaning of one or more of the terms. In some implementations, disambiguation module 350 identifies two terms each associated with one of an entity, an activity, or a location. For example, a first of the two terms refers to a person, and a second of the two terms refers to a location. In some implementations, disambiguation module 350 identifies three terms each associated with one of an entity, an activity, or a location.

Once the task flow processor 336 has completed the structured query for an actionable intent, the task flow processor 336 proceeds to perform the ultimate task associated with the actionable intent. Accordingly, the task flow processor 336 executes the steps and instructions in the task flow model according to the specific parameters contained in the structured query. For example, the task flow model for the actionable intent of “restaurant reservation” may include steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, the task flow processor 336 may perform the steps of: (1) logging onto a server of the ABC Café or a restaurant reservation system that is configured to accept reservations for multiple restaurants, such as the ABC Café, (2) entering the date, time, and party size information in a form on the website, (3) submitting the form, and (4) making a calendar entry for the reservation in the user's calendar. In another example, described in greater detail below, the task flow processor 336 executes steps and instructions associated with tagging or searching for digital photographs in response to a voice input, e.g., in conjunction with photo module 132.

In some implementations, the task flow processor 336 employs the assistance of a service processing module 338 (“service processor”) to complete a task requested in the user input or to provide an informational answer requested in the user input. For example, the service processor 338 can act on behalf of the task flow processor 336 to make a phone call, set a calendar entry, invoke a map search, invoke or interact with other user applications installed on the user device, and invoke or interact with third party services (e.g. a restaurant reservation portal, a social networking website or service, a banking portal, etc.). In some implementations, the protocols and application programming interfaces (API) required by each service can be specified by a respective service model among the service models 356. The service processor 338 accesses the appropriate service model for a service and generates requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameters to the online reservation service. When requested by the task flow processor 336, the service processor 338 can establish a network connection with the online reservation service using the web address stored in the service models 356, and send the necessary parameters of the reservation (e.g., time, date, party size) to the online reservation interface in a format according to the API of the online reservation service.

In some implementations, the natural language processor 332, dialogue processor 334, and task flow processor 336 are used collectively and iteratively to deduce and define the user's intent, obtain information to further clarify and refine the user intent, and finally generate a response (e.g., provide an output to the user, or complete a task) to fulfill the user's intent.

In some implementations, after all of the tasks needed to fulfill the user's request have been performed, the digital assistant 326 formulates a confirmation response, and sends the response back to the user through the I/O processing module 328. If the user request seeks an informational answer, the confirmation response presents the requested information to the user. In some implementations, the digital assistant also requests the user to indicate whether the user is satisfied with the response produced by the digital assistant 326.

In some implementations, the digital assistant 326 includes a photo module 132 (FIG. 3A). In some implementations, the photo module 132 acts in conjunction with the task flow processing module 336 (FIG. 3A) to tag and search for digital photographs in response to a user input.

The photo module 132 performs operations on digital photographs as well as tags associated with digital photographs. For example, in some implementations, the photo module 132 creates tags, retrieves tags associated with fingerprints of a digital photograph, associates tags with digital photographs (e.g., tagging the photograph), searches a photo database (e.g., the photo and tag database 130, FIG. 1) based on a user input to identify digital photographs, and locally stores digital photographs each in association with one or more tags. In some implementations, tags correspond to one or more terms and their associated entity, activity, or location. In some implementations, an entity corresponds to an object (e.g., a common noun corresponding to an inanimate object) or a person (e.g., the name of a person or names of people, common nouns, pronouns, collective nouns). In some implementations, an activity corresponds to a verb or an action. In some implementations, a location corresponds to a place (e.g., a geographic location, such as a city; or a common name for a place, such as a beach or a kitchen).

The photo module 132 includes a photo tagging module 358. In some implementations, photo tagging module 358 tags digital photographs with one or more terms and their associated entity, activity, or location. For example, the photo tagging module 358 tags a digital photograph of a man with an apple in the kitchen of a residence with the tags “person: Brett,” “object: apple,” “activity: eating,” and “location: kitchen” and/or GPS coordinates, and/or time. In some implementations, photo tagging module 358 auto-tags one or more digital photographs. In such implementations, photo tagging module 358 identifies one or more reference fingerprints corresponding to (e.g., matching) a fingerprint of the digital photograph, retrieves one or more tags associated with the reference fingerprints, and associates the one or more tags with the digital photograph. Some examples of image matching with fingerprints can be found in U.S. Pat. No. 7,046,850, for “Image Matching,” filed Sep. 4, 2001, and in U.S. Pat. No. 6,690,828, for “Method for Representing and Comparing Digital Images,” filed Apr. 9, 2001, which are incorporated by reference herein in their entirety.

In some implementations, photo tagging module 358 associates one or more tags with a graphical feature within the digital photograph (e.g., a face or object represented in the digital photograph). In some implementations, photo tagging module 358 associates the one or more terms corresponding to the digital photograph with information corresponding to spatial locations of their corresponding entity, activity, or location (e.g., for displaying the one or more terms in spatial proximity to their corresponding entity, activity, or location.)

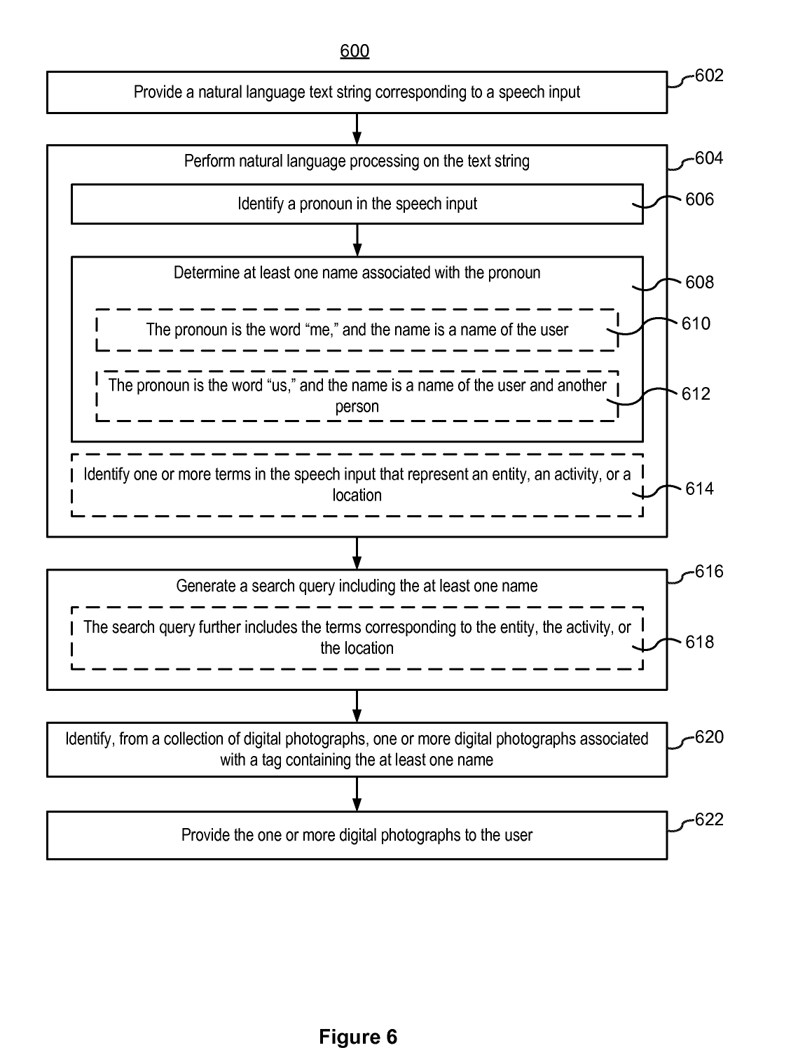

In some implementations, the photo module 132 includes a search module 360. In some implementations, the search module 360 generates search queries used for searching digital photographs based on speech input, as explained in further detail with reference to Method 600 (operations 602-622, FIG. 6) below. For example, for a received voice input corresponding to the search string “find photos of me at the beach,” the search module 360 generates a query “photos AND Bernie AND beach,” where Bernie is the owner of the device, identified through natural language processing by the natural language processor 332. The search module 360 optionally identifies, from a collection of digital photographs (e.g., from the photo and tag database 130, FIG. 1), one or more digital photographs associated with a tag containing the at least one name.

In some implementations, the photo module 132 includes a local tag/photo storage 326. In some implementations, after the photo tagging module 358 tags digital photographs, the local tag/photo storage 326 stores the tags in association with at least one of the digital photograph or a representation of the digital photograph (e.g., a fingerprint of the photograph). In some implementations, the local tag/photo storage 326 stores the tags jointly with the corresponding digital photograph(s). Alternatively, or in addition, the local tag/photo storage 326 stores the tags in a remote location (e.g., on a separate memory storage device) from the corresponding photograph(s), but stores links or indexes to the corresponding photographs in association with the stored tags.

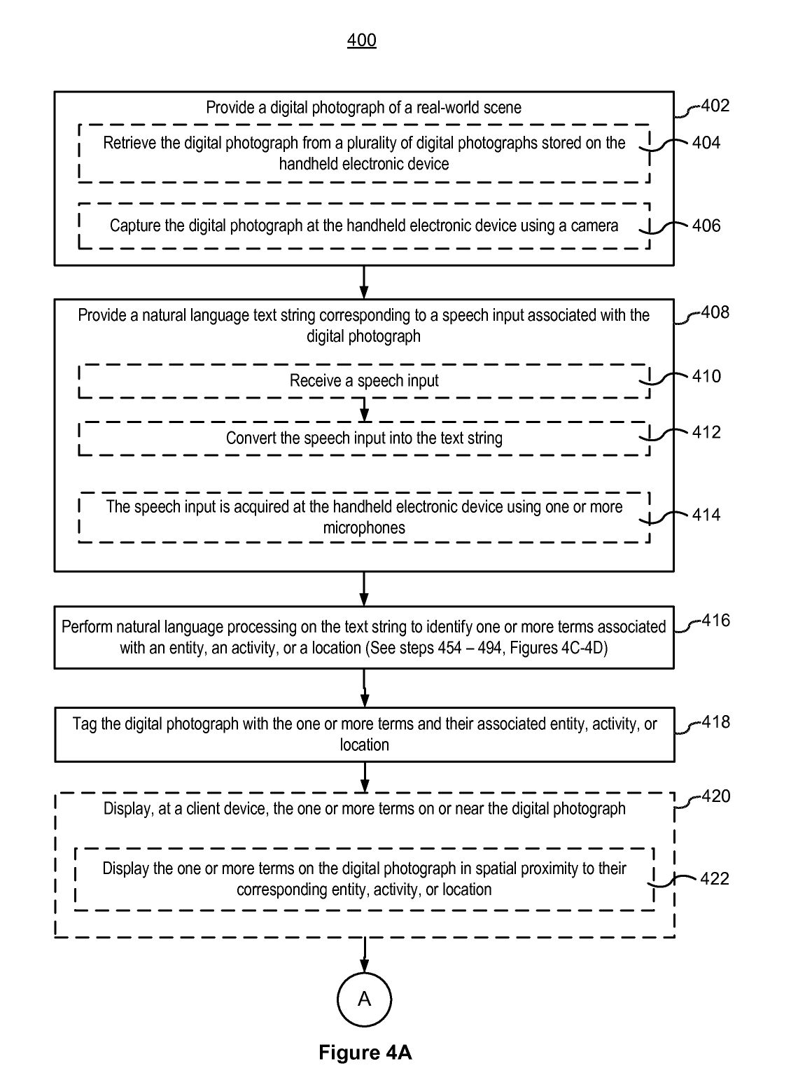

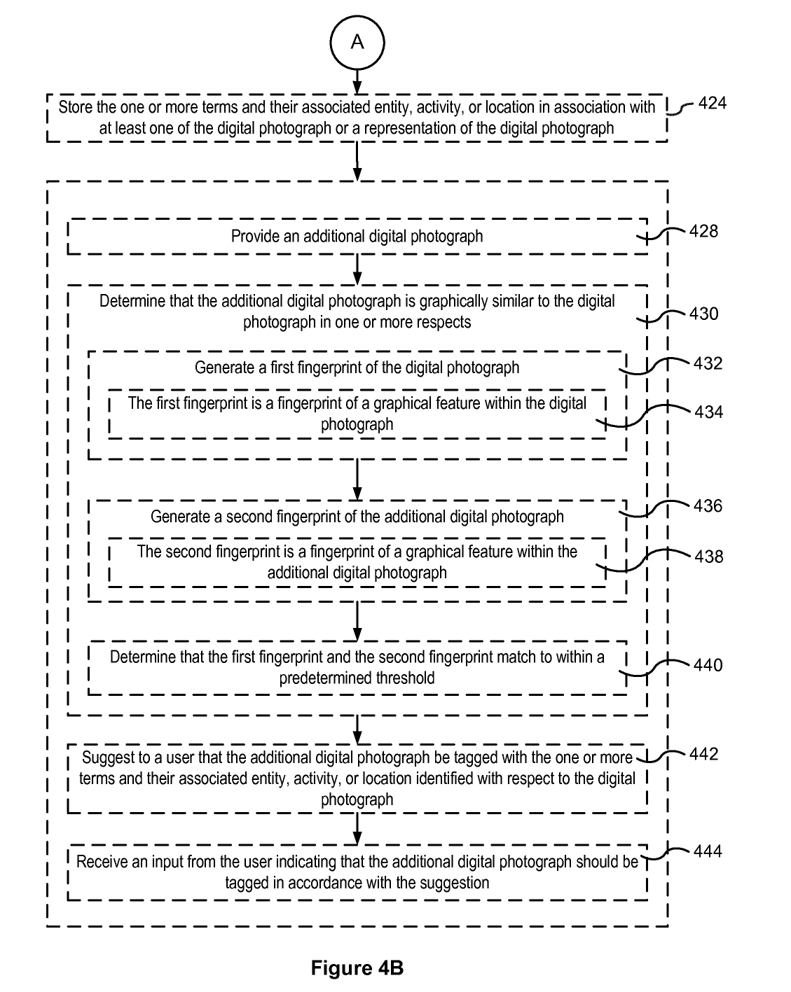

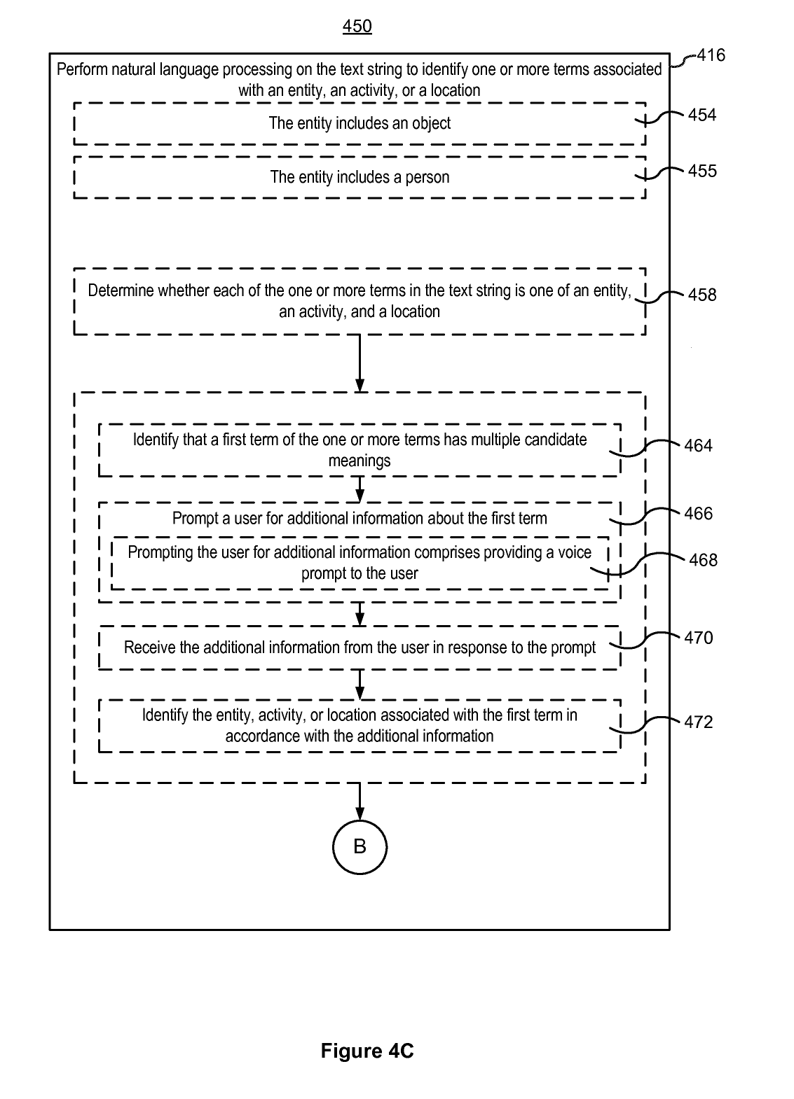

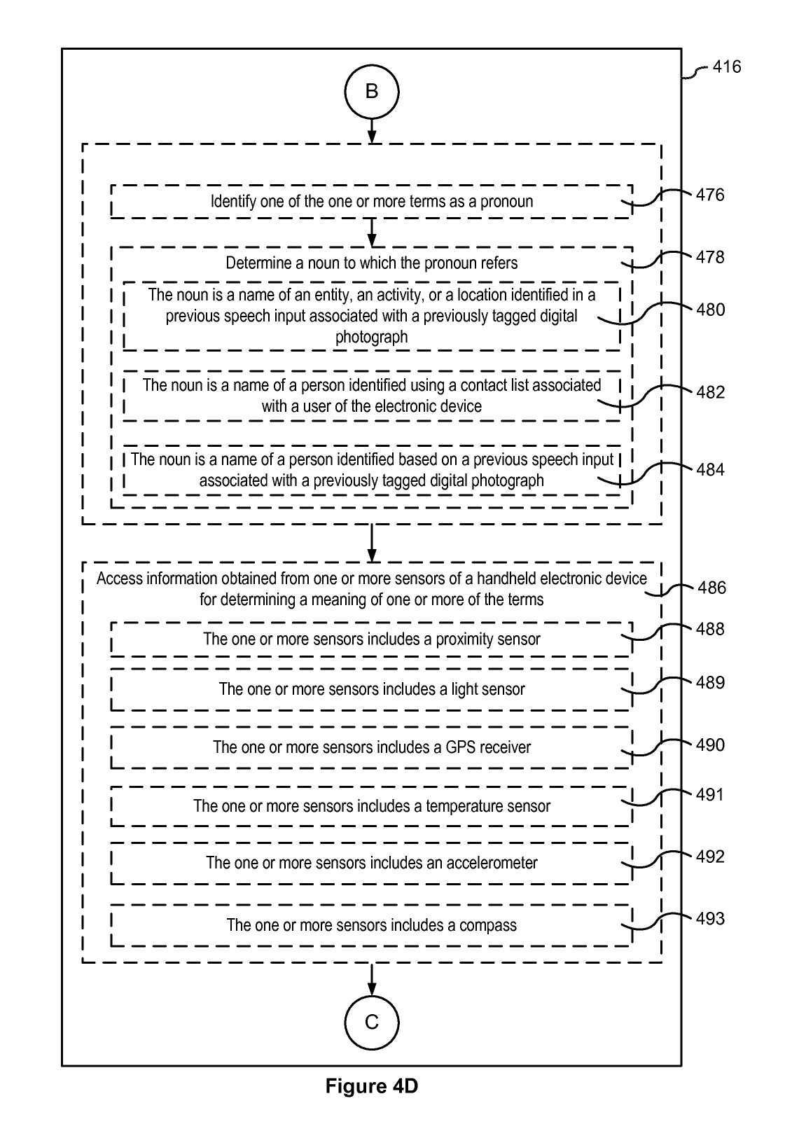

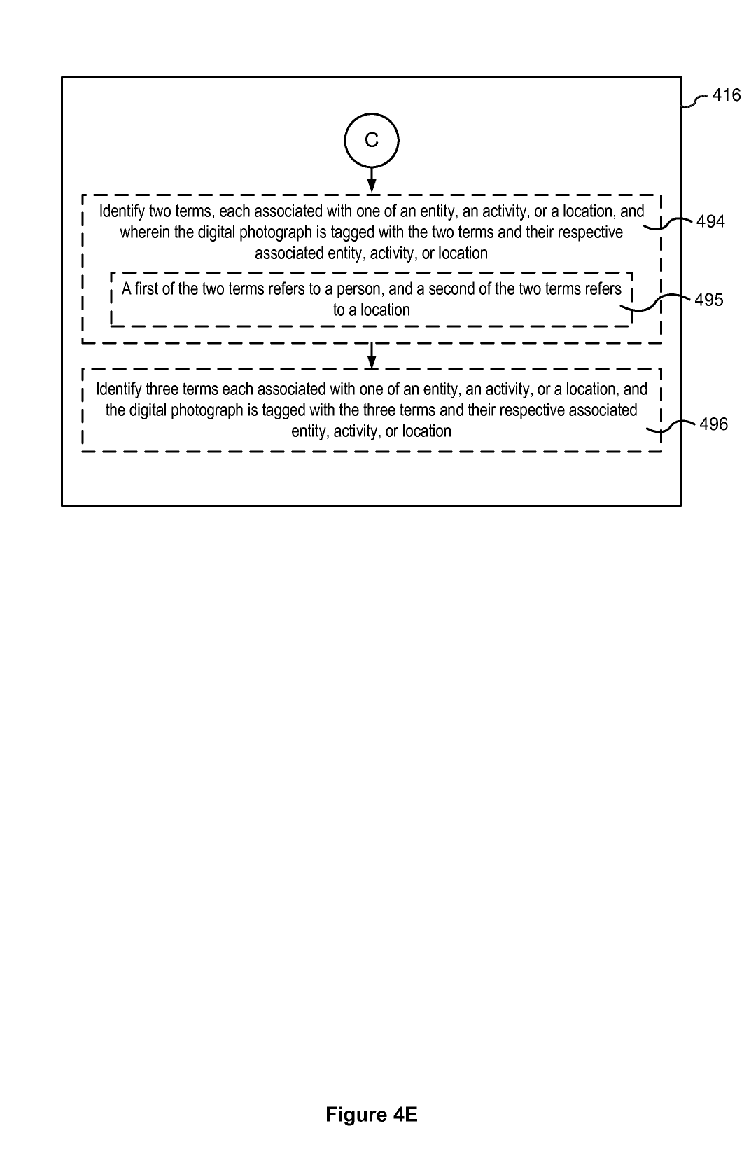

FIGS. 4A-4E are flow diagrams representing methods for tagging digital photographs based on speech input, according to certain implementations. Methods 400 and 450 are, optionally, governed by instructions that are stored in a non-transitory computer readable storage medium and that are executed by one or more processors of one or more computer systems of a digital assistant system, including, but not limited to, the server system 108, the user device 104a, and/or the photo service 122-6. Each of the operations shown in FIGS. 4A-4E typically corresponds to instructions stored in a computer memory or non-transitory computer readable storage medium (e.g., memory 250 of client device 104, memory 302 associated with the digital assistant system 300). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various implementations, some operations in methods 400 and 450 may be combined and/or the order of some operations may be changed from the order shown in FIGS. 4A-4E. Moreover, in some implementations, one or more operations in methods 400 and 450 are performed by modules of the digital assistant system 300, including, for example, the natural language processing module 332, the dialogue flow processing module 334, the photo module 132, and/or any sub modules thereof.

According to some implementations, the following methods allow a user to view a photograph on an electronic device, such as a smart phone, and easily tag the photograph using voice input. However, instead of just transcribing the user input and applying the transcribed words to a photograph, the methods described below allow a range of intelligent tagging, auto-tagging, and searching features, all of which are responsive to natural language commands (such as voice commands). For example, and as described in detail below, a user who is viewing a photo may speak aloud to a device a brief description of a photograph, such as “this is us at the beach.” The disclosed methods can transcribe the utterance, determine the meanings of words within the utterance (e.g., to whom “us” refers), determine additional information about the words (e.g., that “us” refers to certain persons, that “beach” is a location, etc.), and tag the photograph with words from the utterance as well as the additional information (e.g., including the real names of the people, that “beach” is a “location,” etc.).

In some implementations, the methods also provide for automatic tagging of photographs, where tags can be automatically associated with photographs based on their similarity to previously tagged photographs. Such similarity can be determined by comparing representations of photographs or objects within photographs (such as faces, buildings, landscapes, etc.) to stored representations of previously tagged photographs. Accordingly, a user may say for one photograph “this is us at the beach,” and subsequent photographs that look similar are tagged with the same or similar tags. Additional information is also used in some implementations to determine that photographs should be similarly tagged, such as date and/or time stamps, geographical location stamps, and the like.

In some implementations, the methods also provide photo searching functionality, using natural language processing techniques to determine an effective search query based on potentially ambiguous information. For example, if a user requests “photos of us at the beach,” the disclosed methods may determine that “me” refers to particular people, and may further determine that “the beach” likely corresponds to a specific location or event (such as a particular vacation in Hawaii), rather than “any” beach.

Returning to FIG. 4A, in some implementations the digital assistant provides (402) a digital photograph of a real-world scene. In some implementations, the method (400) is performed at a handheld electronic device (e.g., device 102, FIG. 1). In such implementations, providing (402) the digital photograph comprises retrieving (404) the digital photograph from a plurality of digital photographs stored on the handheld electronic device. For example, the digital photograph is retrieved from digital photographs stored on the handheld electronic device (e.g., stored in user data 266 of the user device 104, FIG. 2). In some implementations, providing (402) the digital photograph comprises capturing (406) the digital photograph at the handheld electronic device using a camera. For example, the digital photograph is captured using camera subsystem 220 of the user device 104, as shown in FIG. 2.

The digital assistant provides (408) a natural language text string corresponding to a speech input associated with the digital photograph. In some implementations, providing (408) the natural language text string includes receiving (410) a speech input from a user and converting (412) the speech input into the text string. For example, user device 104 (FIG. 2) captures a digital photograph of a man holding an apple in the kitchen of his house, and subsequently receives a speech input such as “Brett eating an apple in the kitchen.” After receiving the speech input, the digital assistant converts the speech input into a text string (e.g., with the speech-to-text processing module 330, FIG. 3A).

In some implementations, the speech input is acquired (414) at a handheld electronic device using one or more microphones. For example, speech input is a user input acquired at user device 104 using one or more microphones 230 (FIG. 2).

The digital assistant performs (416) natural language processing on the text string to identify one or more terms associated with an entity, an activity, or a location (e.g., with the natural language processing module 332, FIG. 3A). For example, for the text string “Brett eating an apple in the kitchen,” the natural language processor 332 identifies “Brett” as a term associated with an entity (e.g., a person), “eating” as a term associated with an activity, “apple” as a term associated with an entity (e.g., an object), and “kitchen” as a term associated with a location. Moreover, if the text string were “Brett having an apple in the kitchen,” the natural language processor 332 identifies “having” as associated with the activity “eating.” Natural language processing is described in further detail below with respect to method 450, FIGS. 4C-4E.

The digital assistant tags (418) the digital photograph with the one or more terms and their associated entities, activities, and/or locations. For example, the digital assistant (e.g., with the photo tagging module 358, FIG. 3A) tags a digital photograph of a man with an apple in the kitchen of a residence with the tags “person: Brett,” “object: apple,” “activity: eating,” and “location: kitchen” and/or GPS coordinates, and/or time.

In some implementations, the digital assistant displays (420), at a client device, the one or more terms on or near the digital photograph. For example, for the photograph described above, the digital assistant overlays/superimposes (e.g., at the touchscreen 246 of the user device 104, FIG. 2) the terms “Brett,” “eating,” “apple,” and “kitchen” on or near the digital photograph. In some implementations, the one or more terms are displayed (422) on the digital photograph in spatial proximity to their corresponding entity, activity, or location. For example, the digital assistant displays the term “Brett” in spatial proximity to its corresponding entity (e.g., person), the term “eating” in spatial proximity to its corresponding activity (e.g., near his mouth), the term “apple” in spatial proximity to its corresponding entity (e.g., object), and the term “kitchen” in spatial proximity to its corresponding location, on the digital photograph. In some embodiments, the digital assistant displays a subset of the terms in spatial proximity to their corresponding entity, activity, or location.

In some implementations, the digital assistant stores (424) the one or more terms and their associated entity, activity, or location in association with at least one of the digital photograph or a representation of the digital photograph. For example for the photograph described above, the tags “person: Brett,” “object: apple,” “activity: eating,” and “location: kitchen” are stored (e.g., in local tag/photo storage 362) in association with at least one of the digital photograph itself, or a representation of the digital photograph (e.g., a fingerprint of the digital photograph, a hash of the digital photograph, or the like).

In some implementations, the digital assistant performs automatic tagging, or auto-tagging, for photographs. For example, if a user tags one photograph using the methods described herein, additional photographs that are similar can be automatically tagged (with or without user confirmation) by the digital assistant. Also, photographs can be automatically tagged based on their similarity to a shared database of tagged photographs (or fingerprints of photographs), where the database contains tagged photographs from multiple different users.

Accordingly, in some implementations the digital assistant performs auto-tagging for a digital photograph as described herein with respect to operations 428-444. In some implementations, the digital assistant provides (428) an additional digital photograph. For example, after tagging and storing the photograph of a man in a kitchen, as described above, the user device 104 obtains or otherwise provides a digital photograph of a woman in a kitchen of a residence. In some implementations, the digital assistant determines (430) that the additional digital photograph is graphically similar to the digital photograph (e.g., the photograph from step (402)) in one or more respects. For example, the digital assistant may determine that the kitchen of the residence in both the digital photograph and the additional digital photograph are graphically similar.

In some implementations, determining that the additional digital photograph is graphically similar to the digital photograph in one or more respects comprises operations 432-440. In some implementations, the digital assistant generates (432) a first fingerprint of the digital photograph (e.g., the photograph provided in step (402)). For example, the digital assistant 326 may generate a fingerprint (e.g., with the photo module 132, FIG. 3A) corresponding to the entire digital photograph or any part(s) thereof. In some implementations, the first fingerprint is (434) a fingerprint of a graphical feature within the digital photograph. For example, the digital assistant 326 may generate a fingerprint (e.g., with the photo module 132, FIG. 3A) of a person, a person's face, an object, etc. within the photograph. In the example of the photograph of a man in a kitchen, this fingerprint may be a fingerprint of a refrigerator, the man, the man's face, a window in the background, etc.

In some implementations, digital assistant generates (436) a second fingerprint of the additional digital photograph (e.g., the photograph provided in step (428)). In some implementations, the second fingerprint is (438) a fingerprint of one or more graphical features within the additional digital photograph. As described above, in some implementations, fingerprints are generated by the photo module 132 of the digital assistant 326.

In some implementations, the digital assistant determines (440) that the first fingerprint and the second fingerprint match to within a predetermined threshold. For example, the digital assistant (e.g., with the photo tagging module 358, FIG. 3A) determines that first fingerprint and the second fingerprint, which, in the examples provided, both correspond to photographs of people in a kitchen, are sufficiently similar to determine that they match. In some implementations, the predetermined threshold for determining a “match” is about a 50% or greater likelihood that the photographs have at least some common content. In some implementations, a match is found where there is a greater than about 60%, 70%, 80%, or 90% likelihood.

In some implementations, after the digital assistant determines that due to their similarities, a first photograph and an already tagged second photograph should have some (or all) of the same tags, the digital assistant will either tag the first photograph without user input, or it will prompt the user with the suggested tag(s) and allow the user to confirm or reject the tags so that photographs are not tagged with incorrect information. In some implementations, where the digital assistant is confident that the tags are correct (e.g., because the fingerprints are very similar or identical), the tags are automatically applied to the first photograph. In some implementations, where the digital assistant is less confident that the tags are correct (e.g., because the fingerprints are only somewhat similar), the digital assistant prompts the user as described above. The user may then either accept or reject the suggested tag(s).

Accordingly, returning to FIG. 4B, in some implementations, the digital assistant suggests (442) to a user that the additional digital photograph (e.g., the photograph provided in step (428)) be tagged with the one or more terms and their associated entity, activity, or location that were identified with respect to the digital photograph (e.g., the photograph provided in step (402)). For example, the digital assistant 326 displays a user prompt or message on the user device 104 that the additional digital photograph (e.g., the photograph of a woman in the kitchen of a residence) be tagged with “location: kitchen.” In some implementations, the digital assistant receives (444) an input from the user indicating that the additional digital photograph should be tagged in accordance with the suggestion. In some implementations, the digital assistant will suggest incorrect tags because of the inherent difficulty of matching photographs with fingerprints. For example, the digital assistant may suggest “person: Brett” and “activity: eating” as tags for the photograph of the woman in the kitchen. In these cases, the user can simply ignore the suggestions so that the photograph of the woman is not incorrectly tagged. In some implementations, the person indicates that these tags are incorrect, such as by selecting an “incorrect,” “ignore,” or “cancel” button on a touchscreen. This data is then used to adjust and hone the matching techniques and tag suggestion algorithms used by the digital assistant.

As described above, the disclosed photo tagging systems and methods include performing natural language processing on a text string. For example, in order to tag a photograph, a user may say “Brett eating an apple in the kitchen.” Natural language processing is used, for example, to determine what words from this utterance to associate with the photograph, as well as to determine additional information about these terms (e.g., their meanings, their part of speech, whether they are a person, entity, or location, etc.). The results of the natural language processing are used to supplement, replace, define, elucidate, and/or disambiguate the terms in the user's utterance to provide robust, structured tags based on simple, natural language inputs.

Accordingly, FIGS. 4C-4E are flow diagrams illustrating a method 450 of performing natural language processing, according to some implementations. The method includes performing (416) natural language processing on a text string to identify one or more terms associated with an entity, an activity, or a location. (Step (416) is discussed above with respect to FIG. 4A.) In some implementations, the entity includes (454) an object. In some implementations, the entity includes (455) a person. For example, as explained above with reference to FIG. 4A, for a text string “Brett eating an apple in the kitchen,” the natural language processing module 332 identifies “Brett” as a term associated with an entity (e.g., a person), “eating” as a term associated with an activity, “apple” as a term associated with an entity (e.g., an object), and “kitchen” as a term associated with a location.

In some implementations, natural language processing comprises classifying (or attempting to classify) each term of the one or more terms, as described herein with reference to operations 458-460. In some implementations, the digital assistant determines (458) whether each of the one or more terms in the text string is one of an entity, an activity, and a location. In some implementations, the determination is performed by the categorization module 349 (FIG. 3A) of the digital assistant system 300 (FIG. 3A). For example, for the text string “Brett eating an apple in the kitchen,” categorization module 349 determines whether “Brett” is an entity, an activity, or a location; whether “eating” is an entity, an activity, or a location; whether “apple” is an entity, an activity, or a location; and whether “kitchen” is an entity, an activity, or a location, etc. The results of this determination are, in some implementations, included in the tags associated with the photograph, such as “person: Brett,” as described above.

In some implementations, natural language processing comprises disambiguating ambiguous terms, as described below with respect to operations 464-472. If an utterance intended for tagging a photograph has a word that is amenable to multiple possible meanings, the digital assistant can determine the most correct meaning for that word and tag the photograph accordingly. For example, if a user provides an utterance of “Brett eating an apple in the kitchen,” the name “Brett” could refer to multiple different people, and the digital assistant will attempt to determine the particular person to whom it refers. This ambiguity may be detected in any number of ways, such as when a user has multiple people named “Brett” in a contact list, or when other photos have been tagged with different full names such as “Brett Smith” and “Brett Jones,” and it is not clear from the utterance to which “Brett” the user is referring. In some implementations, if the ambiguous term is a person's name, the disambiguation module 350 looks up or searches the user's contact list or electronic address book to determine the most likely name being referred to. Alternatively, or in addition, the disambiguation module 350 refers to the user's list of most frequently or recently contacted names (e.g., “starred” contacts or “favorites”) and gives such names the highest preference when disambiguating the ambiguous names. In some implementations, if the ambiguous term is a place, the disambiguation module 350 looks up or searches the user's contact list or electronic address book to determine the most likely place being referred to. In some cases, the digital assistant engages in a dialogue with the user to determine the correct meaning (e.g., with dialogue processing module 334). In some implementations, steps 464-472 are performed by the disambiguation module 350, FIG. 3A.

Returning to FIG. 4C, in some implementations, the digital assistant identifies (464) that a first term of the one or more terms has multiple candidate meanings (e.g., where the term is an ambiguous first name or a homophone). In some implementations, the digital assistant prompts (466) a user for additional information about the first term. In some implementations, prompting the user for additional information comprises providing (468) a voice prompt to the user. In some implementations, the digital assistant receives (470) the additional information from the user in response to the prompt. The digital assistant then identifies (472) the entity, activity, or location associated with the first term in accordance with the additional information.

Continuing the example from above, for the text string “Brett eating an apple in the kitchen,” if the user has multiple contacts named “Brett” in his contact list, the digital assistant identifies that the term “Brett” has multiple potential meanings As explained with reference to FIG. 3A, the task flow processor 336 optionally requests that the dialogue processor 334 disambiguate this property of the structured query. In this example, the dialogue processor 334 prompts the user for additional information about the term “Brett.” For example, the dialogue processor 334 causes the digital assistant to ask the user “Which Brett?” and displays or reads a list of contacts named “Brett” from which the user may choose; alternatively, the dialogue processor 334 causes the digital assistant to ask the user “Did you mean Brett Smith or Brett Jones?”. In this example, based on the additional information from the user in response to the prompt, digital assistant identifies the entity associated with the term “Brett” (e.g., “Brett Smith”) in accordance with the additional information received from the user. Where the identified person has an entry in a contact list, the tag for that person may be associated (e.g., via a pointer) to the corresponding entry in the contact list.

In some implementations, the digital assistant disambiguates pronouns, as described herein with respect to operations 476-484. For example, for an utterance “me in the kitchen,” the digital assistant will determine to whom “me” refers. In another example, for an utterance “us at the beach,” the digital assistant will determine to whom “us” refers. Accordingly, in some implementations, the digital assistant identifies (476) one of the one or more terms in the text string as a pronoun (e.g., “me” or “us”). The digital assistant then determines (478) a noun to which the pronoun refers (e.g., “Brett” or “Brett and Dion”). In some implementations, steps 476-484 are performed by the disambiguation module 350, FIG. 3A.

In some implementations, the noun is (480) a name of an entity, an activity, or a location identified in a previous speech input associated with a previously tagged digital photograph. For example, a user may say in reference to a first photograph “this is me and my wife at the beach.” Based on user profile information, the digital assistant determines that “me” corresponds to “Brett” and “my wife” corresponds to “Molly.” For subsequent photographs, the user may simply say “this is us at the hotel.” Based on the earlier reference to “me and my wife,” the digital assistant determines that “us” corresponds to the same group of people. In some implementations, the noun is (482) a name of a person identified using a contact list associated with a user of the electronic device. In some implementations, the noun is (484) a name of a person identified based on a previous speech input associated with a previously tagged digital photograph. For example, a user may say in reference to a first photograph “this is me and my wife at the beach.” Based on user profile information, the digital assistant determines that “me” corresponds to “Brett” and “my wife” corresponds to “Molly.” For subsequent photographs, the user may simply say “this is us at the hotel.” Based on the earlier reference to “me and my wife,” the digital assistant determines that “us” corresponds to the same group of people.

In some implementations, the digital assistant determines noun references for pronouns by consulting a calendar associated with the user, social networking posts from a user, other photographs (either associated with the user or not), and the like. In some implementations, the digital assistant uses a time-stamp of the photograph to consult one or more of these data sources to determine what the user may have been doing, and with whom, at that time. For example, if a user says “this is us at the beach” with reference to a photograph, the digital assistant may consult a calendar to determine if there is an entry that provides additional information, such as “Hawaii vacation with family.” In this case, the digital assistant can tag the photograph with the names of the user's family (and also the word “family”). In another example, the digital assistant may consult a social network to identify any postings that are proximate in time to the photograph and that contain potentially relevant information about the contents of the photograph (e.g., “On my way to Hawaii with the fam!”). These techniques are also applied, in various implementations, to other disambiguation tasks, such as disambiguating a proper name, a location, an event, an activity, etc., and/or identifying additional information with which to tag a photograph, (e.g., identifying that a photograph was taken during a vacation, where the utterance did not so indicate).

In some implementations, the disclosed methods are performed at a handheld electronic device. In some implementations, performing the natural language processing on the text string further comprises accessing (486) information obtained from one or more sensors of the handheld electronic device for determining a meaning of one or more of the terms. In some implementations, the sensors are those described above with reference to FIG. 2. In some implementations, the one or more sensors includes (488) a proximity sensor. In some implementations, the one or more sensors includes (489) a light sensor. In some implementations, the one or more sensors includes (490) a GPS receiver. In some implementations, the one or more sensors includes (491) a temperature sensor. In some implementations, the one or more sensors includes (492) an accelerometer. In some implementations, the one or more sensors includes (493) a compass. For example, in some implementations, the digital assistant (e.g., with the photo tagging module 358) accesses GPS information from the GPS receiver to determine where a photograph was taken. In some implementations, the digital assistant (e.g., with the photo tagging module 358) accesses compass information from the compass to determine what direction the electronic device was facing when a photograph was taken. In some implementations, location and direction information is used by the photo tagging module 358 to determine what may be in a particular photograph.

In some implementations, information from any of these sensors, alone or in combination, are stored in association with a photograph for later processing. For example, if a person were to later search for “boating pictures,” the digital assistant (e.g., with the search module 360) could determine that photos taken while moving (e.g., using accelerometer data) and while it was warm outside (e.g., using temperature sensor data) are likely candidates for “boating pictures.” In some implementations, the digital assistant (e.g., the search module 360) with augmented information from geographical maps and sensors such as the GPS Receiver 213 can determine that the GPS coordinates stored in association with certain candidate search results (e.g., digital photographs) correspond to a location on a geographical map over a water body and therefore likely correspond to “boating pictures.” Of course, other information from tags, sensors, calendars, social networking, and the like, are used to select candidate photographs in various implementations.

Turning now to FIG. 4E, in some implementations, the natural language processing (e.g., step 416) includes identifying (494) two terms, wherein each term is associated with one of an entity, an activity, or a location, and the digital photograph is tagged with the two terms and their respective associated entity, activity, or location. For example, for the text string “Martha at the beach,” natural the digital assistant (e.g., with the language processing module 332) identifies two terms—“Martha” and “beach”; the term “Martha” is associated with an entity (e.g., a person) and the term “beach” is associated with a location. The digital assistant 326 (e.g., with the photo tagging module 358) tags a digital photograph with the two terms “Martha” and “beach” and their respective associated entity and location. In some implementations, a first of the two terms refers (495) to a person, and a second of the two terms refers to a location. In some implementations, digital assistant 326 (e.g., with the photo tagging module 358) tags a digital photograph with at least two terms and their respective associated entity and location. Alternatively, or in addition, digital assistant 326 (e.g., with the photo tagging module 358) tags a digital photograph with three terms and their respective associated entity, activity, and location.

Accordingly, in some implementations, the natural language processing identifies (496) three terms each associated with each of an entity, an activity, or a location, and the digital photograph is tagged with the three terms and their respective associated entity, activity, or location. For example, for the text string “Martha reading at the beach,” the digital assistant (e.g., with the natural language processing module 332) identifies three terms—“Martha,” “reading,” and “beach”; the term “Martha” associated with an entity (e.g., a person), the term “reading” associated with an activity, and the term “beach” associated with a location. The digital assistant 326 (e.g., with the photo tagging module 358) tags a digital photograph with three terms “Martha,” “reading,” and “beach” and their respective associated entity, activity, and location.

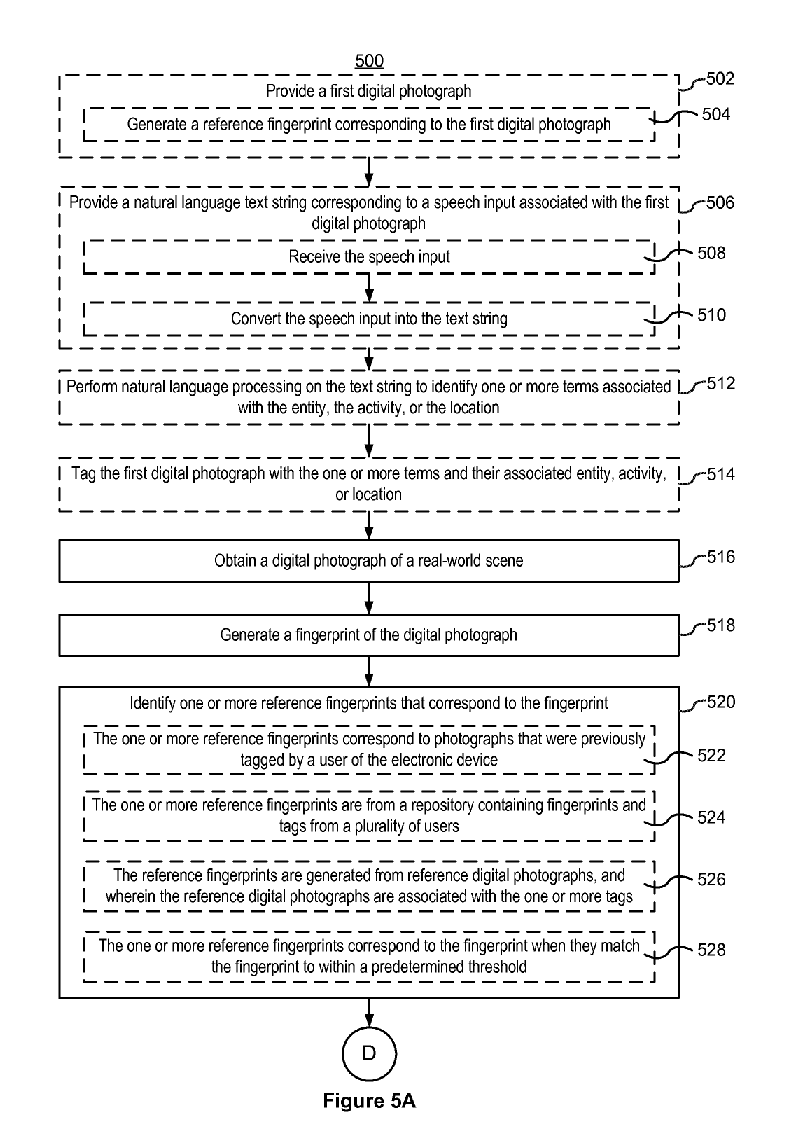

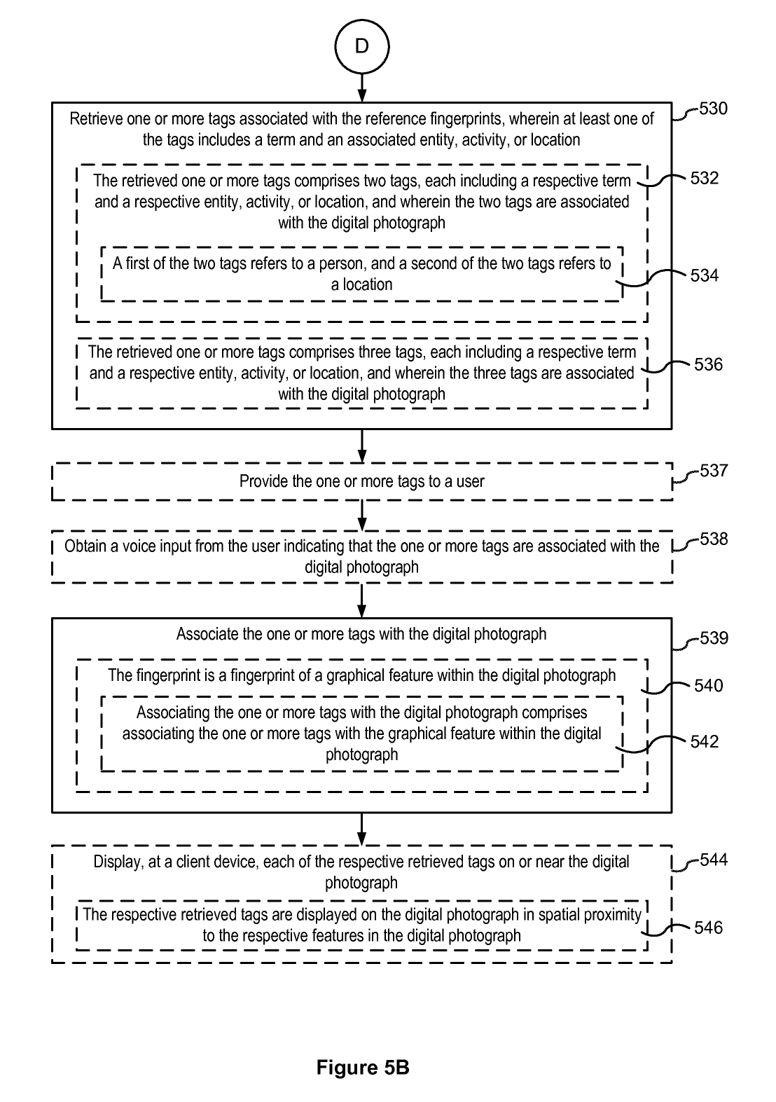

It should be understood that the particular order in which the operations in FIGS. 4A-4E have been described are merely exemplary and are not intended to indicate that the described order is the only order in which the operations could be performed. One of ordinary skill in the art would recognize various ways to reorder the operations described herein. Additionally, it should be noted that details of other processes described herein with respect to methods 500 and 600 (described herein with reference to FIG. 5A-5B or 6 respectively) are also applicable in an analogous manner to methods 400 and 450 described above with respect to FIGS. 4A-4E. For example, the tags, text strings, fingerprints, digital photographs, and terms described above with reference to method 400 and 450 may have one or more of the characteristics of the various the tags, text strings, fingerprints, digital photographs, and terms described herein with reference to methods 500 and 600. For brevity, these details are not repeated here.

FIGS. 5A-5B are flow diagrams representing a method 500 for automatic tagging of digital photographs based on speech input, according to certain implementations. Method 500 is, optionally, governed by instructions that are stored in a non-transitory computer readable storage medium and that are executed by one or more processors of one or more computer systems of a digital assistant system, including, but not limited to, the server system 108, the user device 104a, and/or the photo service 122-6. Each of the operations shown in FIGS. 5A-5B typically corresponds to instructions stored in a computer memory or non-transitory computer readable storage medium (e.g., memory 250 of client device 104, memory 302 associated with the digital assistant system 300). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various implementations, some operations in method 500 may be combined and/or the order of some operations may be changed from the order shown in FIGS. 5A-5B. Moreover, in some implementations, one or more operations in method 500 are performed by modules of the digital assistant system 300, including, for example, the natural language processing module 332, the dialogue flow processing module 334, the photo module 132, and/or any sub modules thereof.

Automatic tagging of digital photographs, as described with reference to method 500, affords fast, efficient, streamlined photo tagging. In some cases, a user's photographs can be automatically tagged (including suggesting tags for approval by the user) based on the similarity between a photo, referred to as a sample photo, and a previously tagged photo, referred to as a reference photo. The reference photo can be the user's photo, such as when a user tags a first photo, and subsequent photos are found to be similar to the first (e.g., multiple photographs at the beach). The reference photo can also be a photo that was taken by another user, or many photos taken by many users. In some implementations, using photos from many different users increases the ability of a photo tagging system (e.g., as provided by the digital assistant system described herein) to identify what a sample photograph represents.

For example, by compiling many photographs, or fingerprints of photographs, that relate to a certain entity, activity, or location, the digital assistant can identify a reference model that can be used to identify that entity, activity, or location in sample photographs. If a database of reference photographs (or fingerprints) includes many photographs that are tagged with “water skiing,” the digital assistant will be able to match a sample photograph of a water skier with the reference photographs based on their similarity. Accordingly, an automatic photo tagging system as described herein is able to leverage the previously tagged photographs of a large group of users in order to provide accurate and useful tag suggestions for untagged photographs. In order to maintain user privacy, actual tagged photographs need not be stored by the digital assistant system to enable this functionality. Rather, fingerprints (e.g., image hashes) may be stored in association with tags, and users' photographs are not stored or duplicated by the digital assistant system.

Turning to FIG. 5A, the digital assistant obtains (516) a digital photograph of a real-world scene. (Steps 502-514 shown in FIG. 5A are discussed below.) The digital assistant generates (518) a fingerprint of the digital photograph. In some implementations, the fingerprint includes information corresponding to one or more graphical features in the digital photograph, as described above. For example, given a photograph of the Washington Monument, the fingerprint may represent the monument itself, rather than a generalized hash or fingerprint of the photograph. When fingerprints of individual graphical objects are stored, it is possible to identify other images that include that object, even if the rest of the image is very different. For example, a photograph depicting the Washington Monument as a small feature in the background may be identified as containing the monument based on one or more photographs that included the monument in a full-frame. In particular, the digital assistant has a representation of that particular graphical feature that can be identified in sample photographs even when the features has a different size, positioning within the photograph, lighting and/or shading, and the like.

The digital assistant identifies (520) one or more reference fingerprints that correspond to the fingerprint. For example, the digital assistant (e.g., with the photo tagging module 358) generates a fingerprint (a sample fingerprint) from a photograph depicting the Washington Monument, and identifies one or more reference fingerprints that match the sample.

In some implementations, the one or more reference fingerprints correspond to (522) photographs that were previously tagged by a user of the electronic device. For example, a user may have previously tagged a photograph of the Washington Monument. In some implementations, the user's previously tagged photographs are used as reference photographs. In some implementations, the one or more reference fingerprints are (524) from a repository containing fingerprints and tags from a plurality of users. For example, the one or more reference fingerprints are obtained from a photo and tag database (e.g., the photo and tag database 130, FIG. 1) that includes photographs and tags from multiple users. In some implementations, the reference fingerprints are generated (526) from reference digital photographs, wherein the reference digital photographs are associated with one or more tags. For example, reference digital photographs may be a set of photographs to which a provider of the digital assistant system owns the rights (e.g., stock photos).

In some implementations, as described above, the one or more reference fingerprints correspond to (528) the fingerprint when they match the fingerprint to within a predetermined threshold, as described above with reference to method 400.

Referring now to FIG. 5B, the digital assistant retrieves (530) one or more tags associated with the reference fingerprints, wherein at least one of the tags includes a term and an associated entity, activity, or location. Continuing the example from above, the digital assistant (e.g., with the photo tagging module 358, FIG. 3A) retrieves one or more tags such as “entity: Washington Monument,” “location: Washington D.C.,” and “activity: sightseeing” that are associated with the reference fingerprint (and hence the sample photograph). In some implementations, the retrieved one or more tags comprises (532) two tags, each including a respective term and a respective entity, activity, or location, and wherein the two tags are associated with the digital photograph. In some implementations, a first of the two tags refers (534) to a person, and a second of the two tags refers to a location.

In some implementations, the retrieved one or more tags comprises (536) three tags, each including a respective term and a respective entity, activity, or location, and wherein the three tags are associated with the digital photograph.

The digital assistant then associates (539) the one or more tags with the digital photograph. Hence, the sample photograph is tagged with one or more of the tags from the reference photograph, based on their similarity. In some implementations, prior to associating the tags, the digital assistant provides (537) the one or more tags to a user. In some implementations, the digital assistant obtains (538) a voice input from the user indicating that the one or more tags are associated with the digital photograph. In some implementations, the digital assistant associates (539) the one or more tags with the digital photograph in response to an indication from the user that the tags are to be associated with the photograph (e.g., via voice input, selecting an item on a touchscreen, and the like). In some implementations, as described above, the tags are automatically associated with the sample photograph without user input.

As described above, in some implementations, the fingerprint used to determine a match between the sample photograph and the reference photograph is a fingerprint of a graphical feature within the digital photograph, such as the Washington Monument (regardless of the size or position of the feature within the photo). In some implementations, associating the one or more tags with the digital photograph comprises (542) associating the one or more tags with the graphical feature within the digital photograph. For example, the tag referring to “entity: Washington Monument” is associated with a particular area within the photograph that depicts the monument.

In some implementations, the digital assistant displays (544), at a client device, each of the respective retrieved tags on or near the digital photograph. In some implementations, the respective retrieved tags are displayed (546) on the digital photograph in spatial proximity to the respective features in the digital photograph, as described above with respect to method 400.

As described above, the reference photographs with which a user's photographs are compared in order to facilitate auto-tagging may be photos that were previously tagged by the same user. Accordingly, in some implementations, steps 502-514 are performed prior to performing step 516 to generate a tagged reference fingerprint for use in the method 500 as described above.

In some implementations, the digital assistant provides (502) a first digital photograph. In some implementations, the first digital photograph is retrieved from digital photographs stored on the handheld electronic device (e.g., in user data 266, FIG. 2). Alternatively or in addition, in some implementations, the digital photograph at the handheld electronic device is captured using camera subsystem 220.

In some implementations, the digital assistant generates (504) a reference fingerprint corresponding to the first digital photograph. In some implementations, the reference fingerprint corresponds to one or more graphical features in the first digital photograph. For example, as described above, given a photograph of the Washington Monument, the fingerprint may correspond to the monument itself (e.g., rather than a generalized fingerprint of the photograph as a whole).

In some implementations, a natural language text string is provided (506), corresponding to a speech input associated with the first digital photograph. In some implementations, the digital assistant receives (508) the speech input. For example, speech input is a user input acquired at user device 104 using one or more microphones 230 (FIG. 2). In some implementations, the digital assistant converts (510) the speech input into the text string. Converting speech to text is described above with reference to FIGS. 3A and 4A.

In some implementations, the digital assistant performs (512) natural language processing on the text string to identify one or more terms associated with the entity, the activity, or the location. Natural language processing according to this step is discussed in detail above with respect to FIGS. 4A and 4C-4E. In some implementations, the digital assistant tags (514) the first digital photograph with the one or more terms and their associated entity, activity, or location, as described above with reference to FIG. 4A. Accordingly, the digital photograph tagged according to steps 502-514 are, in some implementations, used as the reference photograph (from which reference fingerprints are generated) to auto-tag photographs in accordance with some or all of the other steps of method 500.

It should be understood that the particular order in which the operations in FIGS. 5A-5B have been described are merely exemplary and are not intended to indicate that the described order is the only order in which the operations could be performed. One of ordinary skill in the art would recognize various ways to reorder the operations described herein. Additionally, it should be noted that details of other processes described herein with respect to methods 400, 450, and 600 (described herein with reference to FIG. 4A-4B, 4C-4E or 6 respectively) are also applicable in an analogous manner to method 500 described above with respect to FIGS. 5A-5B. For example, the tags, text strings, fingerprints, digital photographs, and terms described above with reference to method 500 may have one or more of the characteristics of the various the tags, text strings, fingerprints, digital photographs, and terms described herein with reference to methods 400, 450, and 600. For brevity, these details are not repeated here.

FIG. 6 is a flow diagram representing a method 600 for searching digital photographs based on speech input, according to certain implementations. Method 600 is, optionally, governed by instructions that are stored in a non-transitory computer readable storage medium and that are executed by one or more processors of one or more computer systems of a digital assistant system, including, but not limited to, the server system 108, the user device 104a, and/or the photo service 122-6. Each of the operations shown in FIG. 6 typically corresponds to instructions stored in a computer memory or non-transitory computer readable storage medium (e.g., memory 250 of client device 104, memory 302 associated with the digital assistant system 300). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various implementations, some operations in method 600 may be combined and/or the order of some operations may be changed from the order shown in FIG. 6. Moreover, in some implementations, one or more operations in method 600 are performed by modules of the digital assistant system 300, including, for example, the natural language processing module 332, the dialogue flow processing module 334, the photo module 132, and/or any sub modules thereof.

The method 600 for searching digital photographs leverages the benefits of natural language processing to generate effective search queries based on natural language utterances that a user may speak in order to locate certain photos. In particular, the methods discussed below may receive from a user a simple utterance such as “find photos of me at the beach,” and return to the user relevant photos, even where the utterance has ambiguous terms or is not in a proper search query format. This obviates the need for a user to use any special query formatting rules, such as whether a space between words acts as an “and” or “or” operator. Rather, a user can simply speak what he or she wants to see, and the digital assistant disambiguates potentially ambiguous words (e.g., pronouns like “us,” “me,” etc.), formulates a query, and returns photos in accordance with the user's request. A similar process is used to disambiguate ambiguous nouns (e.g., common nouns such as “wife,” “brother,” “sister,” “family”) in order to formulate a query and return photographs in accordance with the user's request. In some implementations, method 600 is modified to identify common and/or ambiguous nouns (e.g., step 606), and determine at least one name associated with the common and/or ambiguous nouns (e.g., step 608).

Accordingly, turning to FIG. 6, the digital assistant provides (602) a natural language text string corresponding to a speech input. The digital assistant performs (604) natural language processing on the text string.

In some implementations, performing (604) natural language processing includes identifying (606) a pronoun in the speech input. For example, for an utterance “me in the kitchen,” the digital assistant identifies the term “me” as a pronoun. The digital assistant then determines (608) at least one name associated with the pronoun. For example, in some implementations, the pronoun is (610) the word “me,” and the name is a name of the user. In some implementations, the pronoun is (612) the word “us,” and the name is a name of the user and another person. For example, for a text string “us in the kitchen” corresponding to a user-provided speech input, the digital assistant identifies the term “us” as a pronoun and determines the name of the user (e.g., “Brett”) and the name of another person (e.g., “Molly”). In some implementations, disambiguating pronouns according to method 600 includes other techniques, such as using a contact list, previously tagged photograph, calendar, social network activity, etc., examples of which are described above with respect to method 450. In some implementations, steps 606-612 are performed by the disambiguation module 350, FIG. 3A.

The digital assistant generates (616) a search query including the at least one name. The digital assistant then identifies (620) from a collection of digital photographs, one or more digital photographs associated with a tag containing the at least one name. For example, the digital assistant generates a search query including the at least one name determined from the pronoun in the user's utterance. For example, for a received search string “photos of me at the beach,” the digital assistant (e.g., with the search module 360) generates a query of “photos AND Bernie AND beach,” where Bernie is the name to which the pronoun in the utterance refers. The digital assistant then provides (622) the one or more digital photographs identified in step (620) to a user (e.g., by displaying them on the touchscreen 246).

In some implementations, as part of the natural language processing (608), the digital assistant identifies (614) one or more terms in the speech input that represent an entity, an activity, or a location. Identifying terms representing entities, activities, and locations is described in detail above with respect to methods 400 and 450. In some implementations, the search query further includes (618) the terms corresponding to the entity, the activity, or the location.

It should be understood that the particular order in which the operations in FIG. 6 have been described are merely exemplary and are not intended to indicate that the described order is the only order in which the operations could be performed. One of ordinary skill in the art would recognize various ways to reorder the operations described herein. Additionally, it should be noted that details of other processes described herein with respect to methods 400, 450, and 500 (described herein with reference to FIG. 4A-4B, 4C-4E or 5A-5B respectively) are also applicable in an analogous manner to method 600 described above with respect to FIG. 6. For example, the tags, text strings, fingerprints, digital photographs, and terms described above with reference to method 600 may have one or more of the characteristics of the various the tags, text strings, fingerprints, digital photographs, and terms described herein with reference to methods 400, 450, and 500. For brevity, these details are not repeated here.

The foregoing description, for purpose of explanation, has been described with reference to specific implementations. However, the illustrative discussions above are not intended to be exhaustive or to limit the disclosed implementations to the precise forms disclosed. Many modifications and variations are possible in view of the above teachings. The implementations were chosen and described in order to best explain the principles and practical applications of the disclosed ideas, to thereby enable others skilled in the art to best utilize them with various modifications as are suited to the particular use contemplated.

It will be understood that, although the terms “first,” “second,” etc. may be used herein to describe various elements, these elements should not be limited by these terms. These terms are only used to distinguish one element from another. For example, a first photograph could be termed a second photograph, and, similarly, a second photograph could be termed a first photograph, without changing the meaning of the description, so long as all occurrences of the “first photograph” are renamed consistently and all occurrences of the second photograph are renamed consistently. The first photograph and the second photograph are both photographs, but they are not the same photograph.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method for tagging or searching images using a voice-based digital assistant, comprising:
at an electronic device with a processor and memory storing instructions for execution by the processor:
providing a digital photograph of a real-world scene;
providing a natural language text string corresponding to a speech input associated with the digital photograph;
performing natural language processing on the text string to identify one or more terms associated with an entity, an activity, or a location; and
tagging the digital photograph with the one or more terms and their associated entity, activity, or location.

2. The method of claim 1, further comprising:
receiving the speech input; and
converting the speech input into the text string.

3. The method of claim 1, wherein the entity is selected from the group consisting of: an object and a person.

4. The method of claim 1, wherein the natural language processing comprises:
determining whether each of the one or more terms in the text string is one of an entity, an activity, and a location.

5. The method of claim 1, wherein natural language processing comprises disambiguating ambiguous terms.

6. The method of claim 5, wherein disambiguating comprises:
identifying that a first term of the one or more terms has multiple candidate meanings;
prompting a user for additional information about the first term;
receiving the additional information from the user in response to the prompt; and
identifying the entity, activity, or location associated with the first term in accordance with the additional information

7. The method of claim 6, wherein prompting the user for additional information comprises providing a voice prompt to the user.

8. The method of claim 1, further comprising displaying, at a client device, the one or more terms on or near the digital photograph.

9. The method of claim 8, wherein the one or more terms are displayed on the digital photograph in spatial proximity to their corresponding entity, activity, or location.

10. The method of claim 1, further comprising storing the one or more terms and their associated entity, activity, or location in association with at least one of the digital photograph or a representation of the digital photograph.

11. The method of claim 1, wherein:
the electronic device is a handheld electronic device; and
providing the digital photograph comprises retrieving the digital photograph from a plurality of digital photographs stored on the handheld electronic device.

12. The method of claim 1, wherein:
the electronic device is a handheld electronic device; and
providing the digital photograph comprises capturing the digital photograph at the handheld electronic device using a camera.

13. The method of claim 1, wherein:
the electronic device is a handheld electronic device; and
the speech input is acquired at the handheld electronic device using one or more microphones.

14. The method of claim 1, the natural language processing comprising:
identifying one of the one or more terms as a pronoun; and
determining a noun to which the pronoun refers.

15. The method of claim 14, wherein the noun is a name of an entity, an activity, or a location identified in a previous speech input associated with a previously tagged digital photograph.

16. The method of claim 14, wherein the noun is a name of a person identified using a contact list associated with a user of the electronic device.

17. The method of claim 14, wherein the noun is a name of a person identified based on a previous speech input associated with a previously tagged digital photograph.

18. The method of claim 1,
wherein the electronic device is a handheld electronic device; and
wherein performing the natural language processing on the text string further comprises accessing information obtained from one or more sensors of the handheld electronic device for determining a meaning of one or more of the terms, wherein the one or more sensors are selected from the group consisting of: a proximity sensor, a light sensor, a GPS receiver, a temperature sensor, and an accelerometer.

19. The method of claim 1, further comprising:
providing an additional digital photograph;
determining that the additional digital photograph is graphically similar to the digital photograph in one or more respects; and
suggesting to a user that the additional digital photograph be tagged with the one or more terms and their associated entity, activity, or location identified with respect to the digital photograph.

20. The method of claim 19, further comprising receiving an input from the user indicating that the additional digital photograph should be tagged in accordance with the suggestion.

21. The method of claim 20, wherein determining that the additional digital photograph is graphically similar to the digital photograph in one or more respects comprises:
generating a first fingerprint of the digital photograph;
generating a second fingerprint of the additional digital photograph; and
determining that the first fingerprint and the second fingerprint match to within a predetermined threshold.

22. The method of claim 21, wherein the first fingerprint is a fingerprint of a graphical feature within the digital photograph, and wherein the second fingerprint is a fingerprint of a graphical feature within the additional digital photograph.

23. The method of claim 1, wherein the natural language processing identifies two terms each associated with one of an entity, an activity, or a location, and the digital photograph is tagged with the two terms and their respective associated entity, activity, or location.

24. The method of claim 23, wherein a first of the two terms refers to a person, and a second of the two terms refers to a location.

25. The method of claim 1, wherein the natural language processing identifies three terms each associated with one of an entity, an activity, or a location, and the digital photograph is tagged with the three terms and their respective associated entity, activity, or location.

26. A computer system, comprising:
one or more processors; and
memory storing one or more programs for execution by the one or more processors, the one or more programs including instructions for:
providing a digital photograph of a real-world scene;
providing a natural language text string corresponding to a speech input associated with the digital photograph;
performing natural language processing on the text string to identify one or more terms associated with an entity, an activity, or a location; and
tagging the digital photograph with the one or more terms and their associated entity, activity, or location.

27. A non-transitory computer readable storage medium storing one or more programs configured for execution by an electronic device, the one or more programs comprising instructions for:
providing a digital photograph of a real-world scene;
providing a natural language text string corresponding to a speech input associated with the digital photograph;
performing natural language processing on the text string to identify one or more terms associated with an entity, an activity, or a location; and
tagging the digital photograph with the one or more terms and their associated entity, activity, or location.
